(19) United States
(12) Patent Application Publication
(10) Pub. No.: US 2004/0107141 A1
(43) Pub. Date: Jun. 3, 2004

(54) Method of food production and services cost control

(76) Inventors: Jeffrey L. Conkel, Roca, NE (US); John Allen Barber, Lincoln, NE (US); Only J. Barber III, Lincoln, NE (US)

Correspondence Address: SPENCER, FANE, BRITT & BROWNE, 1000 WALNUT STREET, SUITE 1400, KANSAS CITY, MO, 64106-2140, US

(21) Appl. No.: 10/307,137

(22) Filed: Nov. 29, 2002

(51) Int. Cl. G06F 17/60

(52) U.S. Cl. 705/15

(57) ABSTRACT

A method of managing food service operations is provided which determines variances between the actual quantity of ingredient items used from inventory as compared to the ideal quantity of ingredient items needed to produce food services to identify ingredient waste and/or ingredient pilfering, and/or ingredient loss, and/or incorrect inventory and/or incorrect recipe ingredient quantities, and/or incorrect point-of-sale terminal order entry options, the method of managing also including inventory ordering and inventory receiving reporting by a central management system to allow quantity pricing benefits and to allow immediate adjustment of payments to suppliers and to allow immediate updating of inventories for individual food service operations and to allow immediate determination of individual food service operations minimum inventory quantities. The method further can include immediate determination of individual food service operations minimum inventory quantities for comparison with inventory quantities for previous user selected time periods and/or for comparison with inventory usage projections to assure that proper quantities of inventories are maintained in view of impending business demands and the method also can include using the determined variance between the minimum quantity of ingredient items needed to produce the menu items sold and the quantity of ingredient items used from inventory during the user selected period of time is used to provide incentives to food service workers.

### FIELD OF THE INVENTION

The present invention relates to the management of food service industry and food production control and ingredient inventory management and sales management. In particular the present invention provides a method of comparing the ideal versus the actual ingredient usage in the production of food service items and the serving of food service menu items as well as controlling the related labor and overhead costs associated with such food service industry product and service production.

### BACKGROUND OF THE INVENTION

In the prior art, food service providers and restaurants typically have attempted to monitor the efficiency of food production by monitoring the theoretical food cost of menu items. Such estimations of theoretical food costs can take place on a gross, restaurant wide basis, or on a specific menu item basis. Theoretical food costs on a gross, restaurant wide basis would consist of determining the costs of the ingredients used in each menu item offered by the restaurant followed by multiplication of that cost per menu item times the total quantity of sales of that menu item to produce a gross cost figure of the amount of money the restaurant “theoretically” should have spent on food to prepare the total quantity of dishes served to customers. This number is then compared to the actual dollars spent by the restaurant in purchasing food.

While some gains in restaurant efficiency can be achieved by using this type of procedure, the improvements made are generally the result of calling the employee's attention to the need to pay greater attention to food usage and wastage. No information is provided to the restaurant management or to the individual employees with regard to where in the food preparation process the waste is occurring or with respect to what portion of the food inventory in the restaurant is actually wasted. At best the restaurant can simply advise employees that too much money is being spent on food and to be careful about food wastage.

While such theoretical food cost estimations can be determined for individual menu items, this does not provide any information on which ingredient within the dish is being 11 used efficiently or inefficiently, nor does it answer any questions for the restaurant management regarding inventory loss or excess inventory or the costs associated with inventory items used in producing all food that is prepared by the restaurant.

Therefore, it would be a benefit if a means of monitoring restaurant operations existed which allowed restaurant management to determine the quantities of ingredients being used in all menu items served by the restaurant during a period of time.

It would be a further benefit to the management of restaurants if rapid determination of the use of inventory ingredients used in preparing menu items could be determined.

It would be a further benefit if a means for analyzing the actual use of inventory items and comparing it to the theoretical or ideal or best possible use of inventory items in preparing the menu items actually prepared by the restaurant and served to the public were available.

It would be a further benefit if a means existed for managing restaurant operations in which variations in food purchase prices could be quickly and efficiently applied to the cost of ingredients used in menu items thereby to provide a rapid understanding of increase in costs in the ingredients which contribute to a menu item for evaluation of the sale price of that menu item.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### SUMMARY OF THE INVENTION

The present invention provides a method of managing food service operations by determination of variances between the actual quantity of ingredient items used from inventory as compared to the ideal quantity of ingredient items (the “IvA”) needed to produce food services.

More particularly stated, the present invention provides a method of managing food service operations for a user selected period of time by determining the menu items sold, determining the minimum quantity of ingredient items needed to produce the menu items sold, determining the quantity of ingredient items used from inventory during the user selected period of time, determining the variance between the minimum quantity of ingredient items needed to produce the menu items sold and the quantity of ingredient items used from inventory during the user selected period of time.

The present invention further provides a method of managing food service operations in which the determined variance between the minimum quantity of ingredient items needed to produce the menu items sold and the quantity of ingredient items used from inventory during the user selected period of time is used to identify ingredient waste and/or ingredient pilfering, and/or ingredient loss, and/or incorrect inventory and/or incorrect recipe ingredient quantities, and/or incorrect point-of-sale terminal order entry options.

The present invention further provides a method of managing food service operations in which inventory ordering for one or more food service operations is conducted by a central management system which receives data from the individual food service operations and in which the inventory quantities ordered and the inventory quantities received are compared and variances determined to allow immediate adjustment of payments to suppliers and to allow immediate updating of inventories for individual food service operations and to allow immediate determination of individual food service operations minimum inventory quantities.

The present invention further provides a method of managing food service operations in which inventory ordering and receipt of inventory for one or more food service operations is conducted by a central management to allow immediate determination of individual food service operations minimum inventory quantities for comparison with inventory quantities for previous user selected time periods and/or for comparison with inventory usage projections to assure that proper quantities of inventories are maintained in view of impending business demands.

The present invention further provides a method of managing food service operations in which the determined variance between the minimum quantity of ingredient items needed to produce the menu items sold and the quantity of ingredient items used from inventory during the user selected period of time is used to provide incentives to food service workers.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a chart showing generally the steps of the present invention in developing data at an individual store or restaurant or vendor and the transmission of the data to the central management;

FIG. 2 is a chart showing generally the steps of the present invention used to order inventory for a distant food service unit by a central management.

FIG. 3 is a chart showing generally the steps of the present invention used to determine ideal versus actual inventory usage.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

### Menu Mix Register

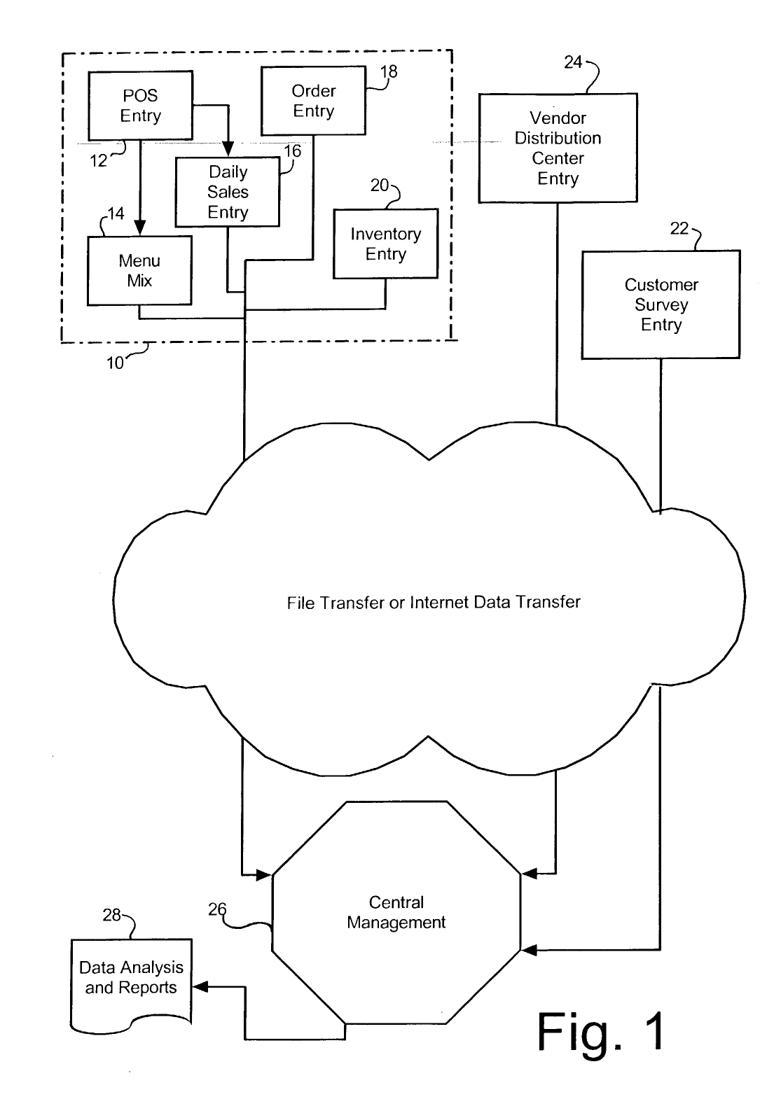

Referring now to FIG. 1, Menu Mix is the term used for items, in particular menu items, sold from the restaurant, food service operation or store 10. For example, if twenty-seven house salads are entered into the point-of-sale (POS) terminal 12 by workers during a sales period, usually one day, twenty-seven house salads appear on Menu Mix Register 14 contained within restaurant, food service operation or store 10. This total will be presented under the menu item identification or menu item nemonic assigned to house salads in Menu Mix Register 14 The POS device in the store is provided with keys for each of the menu items offered by store 10 and the server simply strikes the keys for the menu items that have been ordered.

The POS menu item identifications are transferred to Menu Mix Register 14 and that file is subsequently downloaded into the central office. Menu Mix Register 14 contains only a list of menu items on the store menu or their identification and the quantity sold for the time period being tracked. POS keys and menu item identifications also are available for extra items and substitutions and cancellations such as for “extra ketchup” or “extra dressing” or hold fries” to allow tracking of standard modifications that customers make to the standard Menu Mix Register items. Menu Mix identifications do not include the constituent items that make up a menu item. That is information is developed from the item identifications and quantities that appear on Menu Mix Register 14. It is important that a unique menu item identifier or number is assigned to each menu item. While the menu item identifications or numbers can be for anything store 10 or central management 26 determine to be of interest it is most convenient that a unique identifier be applied to each menu mix item. It is possible for each store 10 to have a different menu item identifier or number for similar menu items or the store can have different menu items available than in other stores. All of these variations in the menu item identifications or numbers can be accounted for in the program operated by central management 26. Therefore, each store does is not required to maintain an identical menu as does another store. For example, stores on the sea coast will have more sea-food items, and stores in the Midwest will have more meat items. It will be appreciated that if an item does not have a menu item identification or number it is not accounted for within the management program operated by central management 26. It may be the case that a store 10 may not account for a consumer requested condiment such as a steak sauce or a hot sauce which is requested by the customer and which is not a menu item.

The menu items ordered by customers and entered into POS device 12 and which enter into the Menu Mix Register 14 Menu also become part of the verification of the sales figures for the day or period of time being tracked. The sales figures will include not only menu sales, but also complementary dishes (comps), voids, discounts and items deleted from bills due to customer complaints. As a result, the menu items stated on Menu Mix Register 14 should correlate with the sales figures for that day or balance with the sales figures for the day. The related information regarding sales in dollars and cents is contained register 16, showing the daily sales for store 10.

It should be appreciated that POS device 12 at a store 10 shows only the menu to the server and does not show the server menu mix register 14. Server entry of information is accomplished as follows. When a server receives an order for French fries, the server goes to the POS menu, presses the “sides” button and selects French fries and indicates that one order of fries is needed. This information is then transmitted to menu mix register 14. At the end of the day or other user selected period of time, the menu mix register will show that one order of French fries was ordered. Restaurants having their POS device 12 integrated with the software of the present invention will have daily sales register 16 updated from the entry of orders updated from entries into the POS system by the server.

It also should be appreciated that Menu Mix, tracked in Menu Mix Register 14 is the gross quantity of items that are sold at the restaurant level. Menu Mix is not a presentation of the ingredients that go into each item. Menu Mix is a reporting of the items that were ordered during the day. If the present invention is not integrated with POS device 12, it is possible to transfer data files from a separate POS system to populate menu mix register 14. Most POS systems currently offered provide a file that can be exported which contains the count of items sold, and that can be used to populate menu mix register 14.

### Daily Sales Register

Two methods of entry may be used for the daily sales register. A manual method and an automatic method. The development of the information in daily sales register operates as follows: when a server enters information into POS device 12, specifically, when the server enters the order of a menu item into the POS device, an order ticket is prepared which is used by the kitchen to prepare the item for the consumer. The same entry of information into the POS device that is a consumer order also generates an invoice bill or check for the consumer. The charges that appear on the customer check, bill or invoice are entered into daily sales register 16. Upon payment of that particular check by the consumer the payment and form of payment such as cash, gift certificate, coupon, complimentary, credit card is entered into daily sales register 16. If the present invention is not integrated with POS device 12, it is possible to transfer data files from a separate POS system to populate the daily sales entry file of the inventive software.

More specifically, when the server enters ordered menu items by entering those menu items into POS device 12, a record of the menu items ordered is transferred to the Menu Mix Register 14 and the Menu Mix Register is updated to reflect the identifications and quantities of those ordered items. Also, it may be the case that an electronic copy of the menu items ordered is transferred to the kitchen for display on a display device located in the kitchen. Alternatively, the particular restaurant operation may rely upon the printing of a kitchen order receipt which is manually presented to the kitchen to initiate preparation of the menu items ordered by the consumer.

At this point in the operation, Menu Mix register or file 14 will not be in balance with the daily sales entry. The balancing between the Menu Mix register and the Daily Sales register is accomplished upon payment of the bill by the consumer. When the means for payment of the bill is presented to the server by the customer, the server enters the appropriate data into the POS terminal which then updates the daily sales register. The appropriate information can consist of all means by which payment of the bill is accomplished including cash or credit card or debit card or coupon for reduction in the price of a meal or an item, or an entry that some or all of the food items on the customer bill are being provided as complimentary items or entry that the items are to be voided out of the system due to customer complaint and a manager decision to not charge for those items, gift certificates, etc.

Referring now to Table 1, daily sales register 16 is able to account for the following categories of sales, at least, liquor, beer, wine, bar tax, food sales, food tax, carry-out sales, sales for a selected time period of each day, number of gift certificates received for each gift certificate denominations, the dollar total of gift certificates redeemed. The daily sales entry register shows discounts that have been offered including at least, coupons, employee meals, manager meals, complaints, promotional complimentary meals, headquarters charges, house charges, and voided amounts.

Deposits are also presented on daily sales register 16 and can be divided into a number of different categories of deposits including total deposits for a particular time of day such as a.m. deposits, p.m. deposits, deposits made by various credit cards such as MasterCard, Visa, Diners, Discover, American Express and others. A special deposit category is provided along with a description of the reason for the special deposit. Such special deposits could be necessitated by, for example, a cash refund by a liquor distributor as frequently liquor sales must be paid for at the time of receipt, and refunds from liquor distributors may be presented in the form of a check payable to the particular restaurant for which a refund is due.

Still referring to Table 1, the daily sales register 16 also can present a gift card total for the particular restaurant which shows the total number of dollars of gift cards sold by the restaurant either from its inception or gift cards that are currently valid and a category of total dollars of gift cards redeemed.

The daily sales register 16 also includes information relating to cash accounts, labor hours, dollars spent to pay for labor, back of house (BOH) hours which relate to time spent by labor in preparing food items and the store for sales, Ticket Time Day (TTD) and Ticket Time Night (TTN) which identify customer sales tickets that were beyond the normal time for delivery of service or food the a particular customer, and an indication of the manager responsible for the morning shift and for the afternoon-evening shift. A comment box is provided which allows the individual restaurant to include comments which may explain any anomalies in the current day's business such as “sales up college homecoming weekend” or “sales down heavy snowfall prevented automobile traffic.” Daily sales register 16 also includes a summary portion which shows bar sales, total sales, cash receipts, total deposits, cash over, cash shortage.

[image]

### Order Entry

Order entry module 18 is the point in the present invention at which a store 10 can place its order for inventory items, both food and cleaning and maintenance items, with central management 26. The central operation of this ordering system allows the central restaurant management 26 to capture cost savings by bulk ordering. It also allows central management or central office 26 to control exactly what inventory items stores or restaurants 10 are able to order. Further, it allows the central office 26 to advise vendors and distribution centers of the quantities of inventory items that will be ordered, thereby allowing the vendors and distribution centers to better maintain availability of inventory items. Order entry module 18 also allows central office 26 to present large quantity purchases to individual vendors or distribution centers, thereby capturing cost savings due to high-volume ordering. As a safety benefit, order entry module 18 allows central office 26 to prevent individual stores 10 from ordering and receiving items which they should not have in their inventory for health and safety reasons such as a spray bug killer. Further, module 18 allows the central office to acquire order information from individual restaurants 10 for use in later confirming the materials actually received by a restaurant which allows the central office to adjust payments to vendors and distribution centers immediately. This avoids the payment of invoices that contain items not actually received by the store and limits payment, after verification of quantities, to that actually received by the store. In this manner central management 26 benefits by avoiding excess business money paid out to vendors and distributors and which money must, several weeks or months later, be refunded to management central office 26 after the variances in orders placed by individual restaurants versus quantities actually received by those individual restaurants are determined.

Order entry module 18 also allows for rapid payment to vendors and distribution centers based on items actually received by the stores when orders are delivered. The rapidity with which this system operates allows central office 26 to offer vendors and distributors very short turn-a-round between the receipt of orders at stores and the payment of bills presented by vendors and distribution centers. For example, with the present invention, and by using Automatic Clearing House (ACH) payment, a vendor can receive payment in three days time after the order is received and verified at the restaurant. This allows central management 26 of restaurant 10 to receive and to negotiate additional discounts from vendors as a result of the rapid payment of vendor invoices.

Referring now to Table 2, an order entry display of order entry module 18 used by store or restaurant 10 is shown. The order entry display can be called up by a manager of a store 10 on the in-store display of a computer or a wireless computer clipboard type device. Table 2 is presented on the in-store computer display device or, alternatively, the manager of the store could simply print off the list, go to the location of the store where the inventory of ingredients and products is maintained so the inventory quantity and/or ingredients on hand can be viewed, and return to the terminal and place the order in that manner. In Table 2, a drop-down window of order entry module 18 is shown having the legend “Go To.” At this drop-down window is shown the various storage areas of store or restaurant 10 such as produce, walk-in, freezer, dry storage, beer cooler, small wares, chemicals, etc. By selecting each one of these storage areas of the store, a different order entry list will appear on the in-store computer display showing the items that are kept in the selected area of the store.

The direct order entry module also can be searched by item number or description by entry of the item number or by entry of the first few letters of the item. For example, entering the letters “CA” into the search window would bring up the various cabbage, cantaloupe, carrot and cauliflower items which the store is to maintain on hand. By using order entry module 18

the store manager can move around to the different storage areas of a store 10 and determine

[image]

what items need to be ordered, and then enter the quantity that the store requires into the quantity window for each item. Once the order entry form has been filled out by the manager, it is electronically submitted to the central management center by any useful electronic file transmission means such as File Transfer Protocol (FTP). The file from order entry module

18 containing a particular direct order entry number is received by central management 26 whereupon the order is divided across the various different vendors and distribution centers which will be supplying portions of this order to the store, and the order is then transmitted to

those various vendors and distribution centers. The vendors and distribution centers then fill the order of the individual store 10 and deliver the order to the store. Upon arrival of the vendor's truck at store 10 the manager of store 10 locates the appropriate order from the Select Received Order screen shown in Table 3 and selects the order to be received. By selecting an order the entire order is displayed for viewing by the manager of store 10 as is

shown in Table 4. Once the proper order has been displayed the correctness of the received order can be determined and the results automatically reported to the central management 26 using the Received Order screen of order entry module 18 (Table 4).

[image]

As shown in Table 4, the received order screen provides an order number which can be matched to the direct order entry number which was previously submitted by the restaurant (although these numbers do not match as between Tables 2, 3 and 4 included herein). The manager of a store 10, upon receiving an order, opens the appropriate direct order entry number to allow the items ordered by the restaurant to be cross-checked against the items actually received by the store or restaurant 10 as they are taken from the delivery truck. As shown in Table 3, the manager of the store 10 is presented with an unchangeable listing of the items actually ordered and a window to insert the quantity of items actually received. A drop-down status slot is provided in which the reason for the any variation can be noted by the manager. For example, while a flat of avocados was ordered, no avocados were received, and the status could be noted as “out of stock.” Eight heads of cauliflower were ordered; only six heads were received, and the status could be noted as “not on truck” as the driver's loading sheet listed eight heads of cauliflower as being loaded onto the truck while only six heads of cauliflower actually appeared at store or restaurant 10. This variation could result from mis-loading of the truck or from the incorrect delivery of part of the restaurant's cauliflower order to a different customer.

[image]

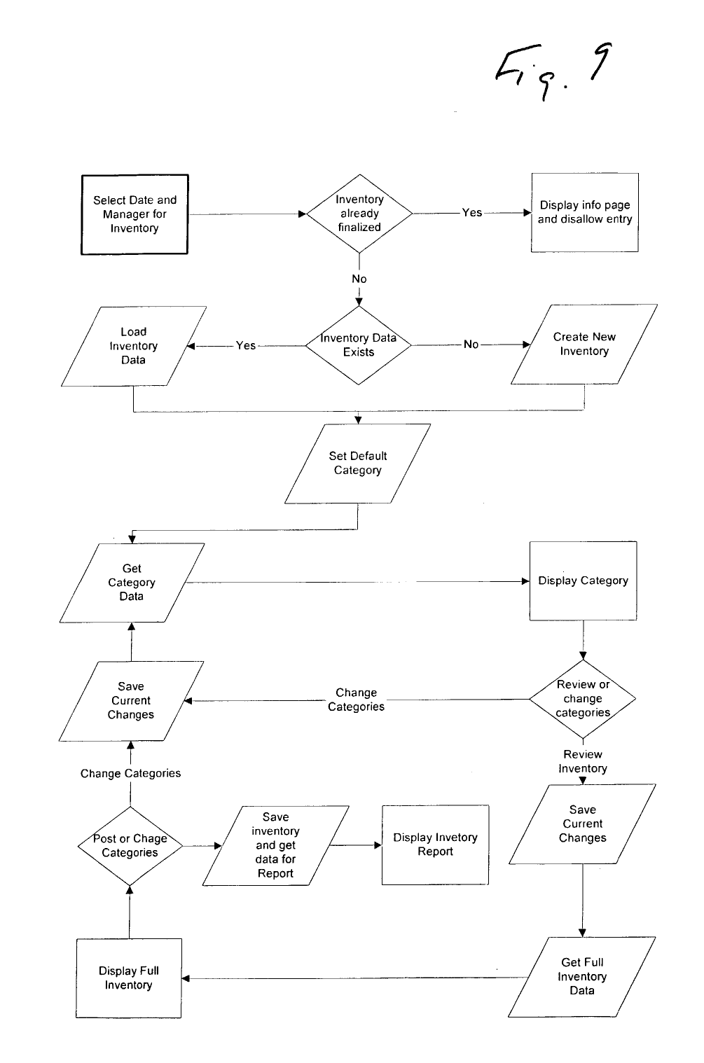

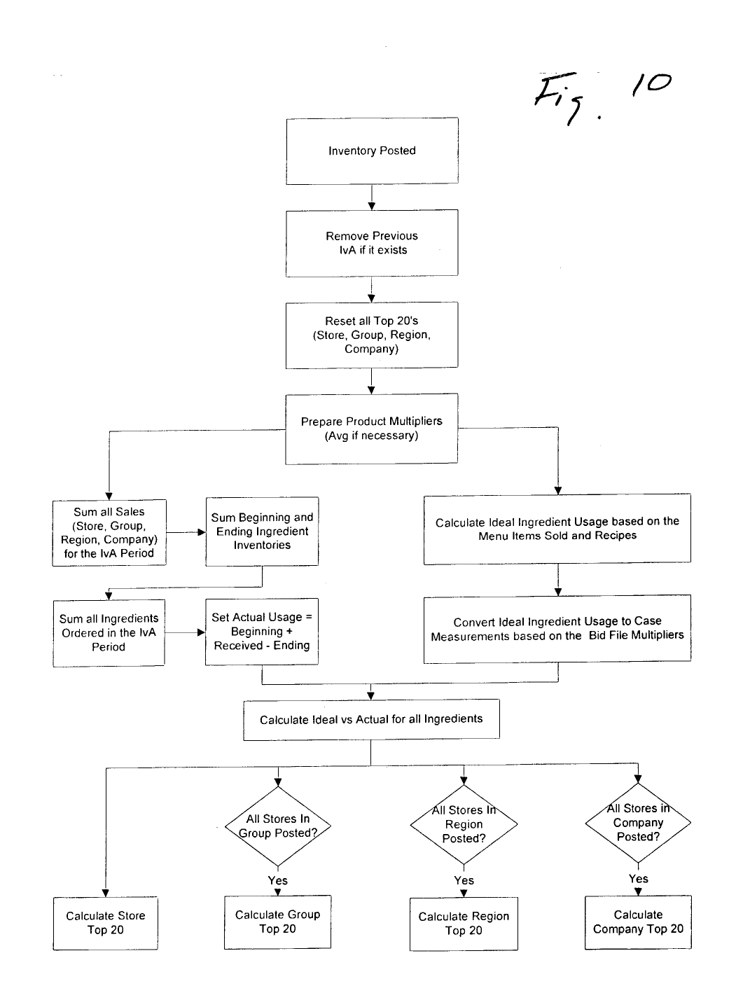

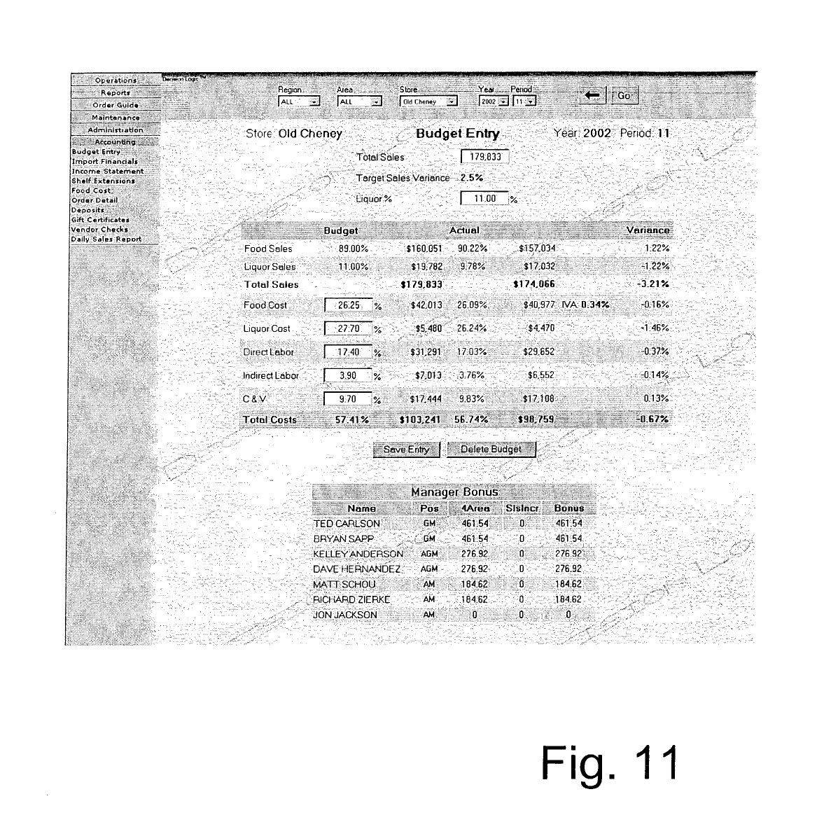

Now referring to FIG. 3, a flow chart of the “received order” process is shown. The process begins at step 331 with the store manager viewing the select order screen of Table 3 and selecting a previously placed order that has not been marked as received. In this case, the manager has selected order number 9842 (Table 3). In step 332, the manager downloads the information relating to order number 9842 which has previously been submitted to the restaurant central management. In step 333, the information relating to order 6096 is displayed to the store manager. It will be appreciated that the manager of store 10 cannot now make any changes to the items or the quantities that were previously ordered. This aspect is critical for proper order payment and for verifying the accuracy of the vendors and distributors. The manager only can verify the receipt of items as ordered or indicate the variation between the ordered items and the received items and indicate the reason for the difference.

In step 334, the manager proceeds to determine the items actually received from the distributor or vendor as they come off the truck. The manager either enters the amount received as correlating with the amount ordered, or the manager enters a different number indicating that a variation exists between the amount ordered and the amount received from the vendor. In step 335, the manager assigns a reason for the variation which can be one of four status possibilities. Those status possibilities are that the item was “out of stock”, “not on the truck”, “substituted,” or “discontinued.” In step 336, the manager then posts the order as received, and the data, as accumulated by the manager on the received order file display (Table 4), is submitted to the central database of the central management 26 (FIG. 1). In step 337, the central database is updated to show that particular order, in this case order number 9842 was received, and in step 338, the invoice amount to be paid to the vendor distribution center is recalculated based upon the order as it was actually marked in as being received by the manager of store 10 in step 334. Also in step 338, the data relating to the status of variations in the received order are saved so that the central management 26 can, over a period of time, review the quality of service being provided by the particular vendor or distribution center and note which items frequently have variations in delivery associated with their orders. In step 339, the actual received order information is then forwarded to the proper files for calculating and updating the ideal versus actual product usage for the particular restaurant to which the order was delivered.

As can be appreciated, it is this immediate recognition of the variation in items ordered and items actually received and the immediate recalculation of amounts due to a vendor is of a great benefit for the conservation of cash flow for the central management 26. Rather than paying the vendor's invoice amount, which can contain items that were not on the truck or damaged or discontinued or out-of-stock, the vendor is only paid for items actually received or for substituted items. This allows central management 26 to retain its cash. In the prior art method of operation, it would be typical for the invoice amount to be paid to the vendor, and for the individual store to submit to central management 26 credit slips or notices in variations in received amounts for which the central management should claim a credit from the vendor. However, in typical operations, this results in over payment of central management cash to the vendor or distribution center which must then be followed by billing adjustments to the central management's account some time later, such as thirty days or quarterly. This process only benefits the vendor or distributor by providing the use of central management cash to the vendor or distributor for a period of time until it is reimbursed to the central management. Under the present invention, this loss of cash flow to central management 26 is avoided by immediate adjustment of the invoice to be paid to the vendor or distribution central. This adjustment is immediately confirmed as proper by the store manager's cross-check of items that are actually received at the store and, if desired, the confirmation of those variations in that received order by the truck driver. As a result of this procedure of the present invention, the central management no longer bears the burden of both having to suffer under the improper delivery of materials to the restaurant by the vendors and the added burden of having to also pay, albeit for a limited time, for the vendor's errors.

It also will be appreciated that this process eliminates the time and effort of central management having to track order variations and credits over a period of time and then apply to the vendor for reimbursement. This prevents the central management from paying for items that were either “not on the truck” or received as “damaged” and avoid the need to pay out cash for these items and then reclaim that money by tracking order credits. The status area on the Received Order display of Table 4 also includes the possibility of substitution of products which may or may not require correction of the invoice. For example, if a thirty pound case of cheese was ordered, and the distribution center was out of that size or brand, they might substitute a twenty pound case of cheese but fail to mark changes on their invoice. This would result in the restaurant receiving only two-thirds of its order and would result in an overcharge to central management. Substitutions that are not in conformance with specifications or pricing can be noted at this point. This allows changes to be made the invoice amount to be paid to the vendor in step 338 and changes to be made in step 339 to the calculation of inventory quantities and menu item quantities which are to be used in the Ideal versus Actual (IvA) analysis which also is provided under the present invention. As part of the process of the present invention, it often will be the case that product data research exists for substituted items thereby allowing the central management to understand that the twenty pound case of cheese substituted for the ordered thirty pound case of cheese does not contain the equivalent amount of slices of cheese that two-thirds of the thirty pound case would provide. Therefore, additional adjustments would be required in step 339 to properly calculate that particular restaurant's IvA even though, with respect to cost, the twenty pound case of cheese maintains the proper pricing ratio of being only two thirds the cost of the thirty pound case of cheese which was ordered.

The present invention also allows manual insertion of received items which allows proper updating of the IvA module. For example, if an order for twenty pounds of tomatoes was not received by the restaurant and is reported as such on the received order file which is transmitted to the central office, the restaurant will still have a need for the twenty pounds of tomatoes. The restaurant manager is then able to go to a nearby grocery store and purchase the twenty pounds of tomatoes, or as will be described later, the manager can go to a nearby restaurant which is operated by the same central restaurant management organization 26 (FIG. 1) and acquire twenty pounds of tomatoes and then report to the central management that the twenty pounds of tomatoes were acquired. This information is then used in step 339 to properly calculate the products on hand at store or restaurant 10 (FIG. 1) for proper determination of the restaurant's inventory and its IvA which will be discussed in greater detail later in the specification. It will be appreciated that such an acquisition of tomatoes falls outside of the standard payment method. In the case of a purchase from a store 10, a restaurant check will be written by the manager for the product purchased, and the amount of that check will be immediately submitted to central management 26 which can then add that money to the checking account of store 10 to cover the check that was written by the manager. In this manner, the present invention allows for updating and maintenance of individual restaurant “zero balance” checking accounts. In similar manner, if the restaurant manager acquired the additional tomatoes from an associated restaurant, each restaurant manager will notify central management 26(FIG. 1) of the transfer of the tomatoes so that the twenty pounds of tomatoes can be removed from the inventory and IvA calculation of the restaurant providing the tomatoes and the twenty pounds of tomatoes can be added to the inventory and IvA calculation of the restaurant receiving the tomatoes. The manual system of order receipt entry also allows for the use of vendors or distribution centers which are not computer equipped. Thus, when it is necessary, particularly for novelty items which may be needed for a particular promotion or which must be acquired from a small vendor which is not electronically equipped, the items received can be manually entered into the system to update step 339 and the IvA for the manually received items.

The order entry module only will allow certain items to be ordered on a “broken case” basis. A “broken case” is the ordering of a quantity of an item that is at less than a standard package. For example, if avocados are packaged twelve in a box and you order three avocados, there will be a “broken case” charge for the three avocados which had to be removed from a full case. The present invention ordering program prevents managers from ordering broken case items except in particular circumstances in which it has been determined that the small use of the item relative to the cost justifies the additional broken case cost.

### Inventory Entry

Again referring to FIG. 1, the inventory entry module 20 at store 10 allows the weekly inventories, or any inventory, to be entered into the system by the individual stores or restaurants 10. The inventories from inventory entry module 20 are required to allow calculation of the Ideal versus Actual (IvA) of goods and ingredients for a particular time period. In brief, the on-hand inventory of the restaurant is submitted to the central management and subtracted from the starting inventory to allow determination of inventory used which is then combined with information from the menu mix register 14(FIG. 1) for determination of the IvA as will be described in detail hereinafter.

Referring now to Table 5, as inventory is taken the inventory multipliers are used to determine the exact amount of product on hand at each store in an amount which can be utilized in making a comparison of product production both in terms of actual product production and ideal product production. For example, cheese would not be reported as two blocks of cheese or two pounds and fifteen slices of cheese, rather, the weight of the cheese is determined and the multiplier conversion factor for cheese is utilized which converts the pound weight into the number of slices of cheese which are provided by that weight of cheese. Therefore, instead of two pounds and fifteen slices of cheese, the manager reports 2.94 pounds of cheese which converts to 47 slices of cheese based upon the multiplier conversion of sixteen slices per pound which is the result of actual determination through product research. This calculation, of course, applies sliced cheese or cheese intended to be sliced. A different multiplier would be applied to, for example, the weight of grated cheese. In that case grated cheese may be used on the basis of a ⅛ cup volume and a weight of 2 pounds of grated cheese could present 64 ⅛ cup volumes for use in preparing menu items. Avocados, for yet another example, are reported on the basis of “each,” therefore, an actual count of the number of avocados present in the store is required, and it would be reported, for example, twenty-seven avocados. As will be discussed hereinafter, a recipe multiplier also is used in the present invention. The recipe multiplier would apply between ingredients and particular menu item recipes.

As a result, for ideal versus actual functions, the determined inventory is subtracted from the starting inventory, and the orders received are added to the amount to determine the actual inventory on hand at each restaurant and the actual usage of inventory at each restaurant. The determination of actual usage is then applied to the inventory multiplier to provide the actual usage for that restaurant on the basis of quantities that can be usefully applied to the Ideal vs Actual usage determination which is described in detain hereinafter. In making the inventory, a display such as that presented in Table 5 is used. The display of Table 5 allows the manager to use the “go to” drop down menu to observe lists of inventory items according to the location in the store 10 (FIG. 1) where the items are kept. It should be

appreciated that once the inventory is entered by a manager and submitted to the central management, that the IvA will be produced. Therefore, once the inventory is submitted, changes to the inventory are not permitted by calling up a previous inventory submission and making changes to it. In this manner, the present invention avoids “catch-up” adjustments being made to the actual inventory upon a restaurant manager noticing that a problem exists with the IvA usage in the store. For example, if the IvA of a store indicates that the ideal versus actual usage of steaks in a store was ten steaks in excess of the ideal usage, the store manager, upon noticing that a case of ten steaks had not been reported on the inventory, could not simply go into the inventory and correct that entry. The “rights” for such an inventory correction are assigned to upper levels of management, and the store manager would have to contact a more senior manager to make changes to the inventory entry. In this manner, the integrity of the system is maintained, and individual store managers cannot, after examining the IvA usage, make changes to their inventory to account for discrepancies in the ideal versus actual usage.

[image]

### Customer Satisfaction Vendors

Referring again to FIG. 1 the entry of customer satisfaction information with the remote survey providers or vendors module 22 will be discussed. It is often the case that an outside analysis company or vendor 22 will be used to track, develop and present customer satisfaction information which is used by the central management 26 and store 10 managers to determine the operation quality of restaurant. The customer satisfaction vendor's input module 22 allows the various vendors used to monitor customer satisfaction to transmit their findings to the central management office. The central management 26 then analyzes and correlates the information into reports for both management and individual store examination. Such information can include secret shopper-type of activity. Alternatively, individual customers may receive a gift certificate which can be activated by the customer calling a toll-free number after the customer leaves the restaurant and answering questions regarding the nature of their visit to the restaurant. After responding to the survey, the customer receives an activation number for the gift certificate. The results of these call-in interviews are tabulated by the customer satisfaction contractor and transmitted to the central management through the customer satisfaction vendor's input module 22.

The information requested from the customer can be, for example, food quality and service quality questions such as “was the food hot”, “did the manager stop by your table to inquire about your visit”, “was your server prompt with your order”, “was your order prepared to your expectations’, etc. The customer satisfaction vendor's input module 22 allows a central restaurant management office 26 and which owns several different brands of franchised restaurants, to use different customer satisfaction vendors for each of the different restaurant types. The survey providers or vendors module 22 allows a central restaurant management entity 26 to receive customer satisfaction reports from several different vendors and several different types of reports from several different vendors. Management 26 can, by use of the present invention, allocate those reports to the particular restaurant franchise brand to which they relate. In this manner, a central restaurant management entity can, if it chooses, use the same vendors and distribution centers for the various franchise brands which it operates while accounting for the different customer satisfaction vendor entities which only apply to one particular franchise brand or another and without the need to have special reporting or input modules for each different vendor.

This survey providers or vendors module 22 also allows the daily or weekly input of information from the customer satisfaction vendors and from the customers, thereby allowing immediate understanding of the public's perception of the service being offered and the immediate determination of the acceptability or customer satisfaction regarding a particular promotion which may be offered by a particular restaurant or group of restaurants. This immediacy of information permits rapid analysis of the success of promotions based on customer perception of the promotional product, thereby allowing the restaurant to make changes or adjustments in the promotion to better serve customers.

Vendors and Distribution Centers

Still referring to FIG. 1, the vendor/distribution center module 24 allows transmittal of information to the central management that is required to enable on-line ordering by central management 26 and restaurants 10 of all store inventory items. Vendor/distribution center module 24 is used by all product vendors that provide, for example, food, cleaning equipment, small wares, customer supplies, cleaning equipment and supplies. Food vendors may be split among produce providers and providers of other items. Alternatively, all food may come from a single vendor. The present invention is able to split orders from individual stores 10 over a number of distribution centers or product suppliers.

Vendor/distribution center module 24 is, essentially, the bidding inputting of what 11 vendors and what supplies are available for the restaurant to order. These have been previously determined by the central office which has requested bids from suppliers for a product for at least a set period of time. Module 24 also is used to exclude items that the restaurants 10 are not permitted to stock or order such as spray bug killers and the like which are not allowed to be used in restaurant situations. Through this control mechanism of module 24 central management 26 can prepare order guides for the individual stores 10 which are presented to the individual stores under order entry module 18.

Referring now to Table 6, the bid file display is shown which the various preselected vendors and distribution centers, use in vendor/distribution center module 24 to submit Bid Files to central management 26. The vendor Bid Files contain the current pricing for each item the vendor is authorized to supply to stores 10. For example, Vendor A, under the category Bread, will provide a listing of a number of bread items for which they are the provider. The information provided by the vendor will include the vendor's item number, the Universal Product Code (UPC) the description of the item, the brand, the package or size description, and the price. The item listing in the bid file also will include the date on which this information was most recently submitted as a date in the “last updated” column of the bid file. It is from this submitted bid file that the central office 26 can select the items to be placed on the order entry list of Table 2 which is actually used by the stores for ordering inventory.

Central office 26 is able to pull up bid files from the individual companies and examine the products and prices and the date of update for each item that has been submitted by the vendor. This information submitted by the vendor is periodically checked by agents of the central office to determine if the actual package or size or weight or item count that is stated on the bid file actually corresponds to the actual product received. For example, it can occur that a product is delivered to stores 10 (FIG. 1) in boxes which display out-of-date information. The provider of bacon, for example, may have in stock shipping cartons which state two pounds bacon, 24 slices when, in fact, the boxes contain two pounds but the slices have become thicker and the slice count has thus changed, and only eighteen slices are now contained in the two pound box. This sort of verification of actual

[image]

package content must be constantly checked and verified by central office 26 so the proper breakdown of ingredient items that are actually used in the dishes prepared in the restaurant 10 can correlate properly with the actual usage of inventory items. This then permits the final in-store inventory count at the end of a user selected time period to accurately reflect the usage of ingredients in the menu items reported to central management 26 from the menu mix register 14 (FIG. 1).

By way of further example, to illustrate this point, under the intended restaurant procedure, a bacon cheeseburger is to receive two strips of bacon on each cheeseburger. When a cheeseburger is reported to the central management office 26 by menu mix register 14 and showing that on a particular day, twelve bacon-cheeseburgers were sold, this will equal 24 strips of bacon. When this count of cheeseburgers from the menu mix file is broken down into its constituent parts using the recipe multiplier for the bacon-cheeseburger, it will show that the restaurant should have used two pounds of bacon in preparation of the twelve cheeseburgers. This is a result of the calculation that a two-pound box of bacon, when operated on by the inventory multiplier for bacon, contains 24 strips of bacon, and when this quantity is operated on by the recipe multiplier for bacon-cheeseburgers of two strips of bacon used for each cheeseburger, the result is that two pounds of bacon will be used in the preparation of the twelve bacon-cheeseburgers. However, as manufacture changes in the bacon count have produced two-pound boxes of bacon having only eighteen strips of bacon, this will result in the restaurant workers using 2.67 pounds of bacon to produce the twelve cheeseburgers. Without the constant checking of the portions of inventory packages actually received from the distribution center to determine the proper inventory multipliers, this problem would result in the over usage of bacon in recipes and the increase in costs and possibly the incorrect belief that employees are pilfering bacon.

Another aspect of this constant actual checking of the packaging and weights and package counts of items received from distribution centers can be shown in the same analogy drawn to bacon. Specifically, it is not unknown for manufacturers to decrease the quantity of a product actually contained within a carton and fail to properly adjust the count on the carton or to adjust the pricing. The verification of products received from distribution centers can quickly locate these changes in product quantity and cost relationships and allow the central office to either terminate that product or to adjust inventory or to adjust, unilaterally, the price of the product to be paid to the supplier in view of the failure to provide the actual quantity of the product at the bid price under the terms of the contract with the vendor. As will be described later on, this procedure of actual verification of product weights and item counts and packages is critical to proper functioning of the ideal ingredient usage versus actual ingredient usage (IvA) function of the present invention. It will also be appreciated from this verification process that the information is split into multiplier information which is used for inventory purposes in the individual stores, and the information is used for a recipe multiplier information which allows determination of how many menu items can be prepared from the inventory on hand or how much inventory should have ideally been used to prepare a particular number of menu items as illustrated above for bacon-cheeseburgers.

An example of this package size counts and multipliers which are developed for use in both inventory and menu usage multipliers can be illustrated for meatballs which are used in, for example, spaghetti and meatballs recipe. The meatballs are used on the “each” basis. A serving of spaghetti and meatballs will contain five each meatballs, and the meatballs are received in a case which contains twelve meatballs per flat, and there are seven flats in a case. This type of information breakdown allows the precise breakdown of inventory quantities and the precise buildup of needed inventory based upon expected sales of menu items, as well as providing usage verification between ideal and actual usage (the IvA) analysis for each inventory item contained in the store and for each menu item sold by the store. Another example of the critical nature of this evaluation is with sour cream. For example, sour cream is purchased in twenty pound containers, however, sour cream is used on a volume ounce basis not a weight ounce basis and only fourteen volume ounces of sour cream are available in each pound of sour cream. Therefore, the variations between amounts and quantities and measurements being used in menu items versus the weights and measures and counts that are placed into shipping packages and the comparisons therebetween become critical to proper operation of the present invention. Once again, examining the sour cream issue, twenty pounds of sour cream will provide 280 volume ounce portions, whereas if the twenty pounds were assumed to provide the same number of ounces on a weight basis as on a volume basis, sixteen one ounce portions per pound would be expected from each pound of sour cream. This would result in a count of 320 one ounce portions (by weight) per twenty pounds of sour cream. This calculation when applied to recipes would be inaccurate as the actual use of the sour cream product in the restaurant is on a volume, not weight, basis.

### Sales Reporting

Sales reporting provides a number of different reports, comparative reports and compilations of information based on information obtained from the daily sales register 16 of each store 10. This information is transmitted to central management 26 by each store or restaurant 10. All the information reported on the daily sales register 16 is presented in the sales reporting module and is accumulated on a weekly basis or on a period of accumulation that is selected by the user. Any prior sales information for a particular store 10 is available to that store 10 and can be called up by the store for examination by the store managers.

Another aspect of the sales reporting module is the management data reports which are developed from the daily sales register 16 (FIG. 1) that is submitted by each store 10. The management data reports include the sales history for each store 10 and which provides sales data of each store over a time span including the entirety of the time period the invention has been applied to the store. In particular, the sales reporting module provides comparisons between the current sales data for any store 10 and the sales data for the store for same time period in the previous year period.

Sales reporting can be presented on an individual store 10 or by management can select groups of stores, or company wide sales as is shown in Table 7 can be shown under sales reporting depending on the desire of the user. Sales reporting also can present period comparisons for each of these groups and present the differences between the sales figures for the two periods selected. The invention allocates hierarchical access to the various reports allowing each user to be assigned specific user viewing rights and/or user action rights. These rights can vary from administrative level rights which would provide user rights for every function and all viewing down to manager level rights which only would have rights to make entries into order entry module 18 (FIG. 1) and inventory entry module 20 (FIG. 1) and certain portions of daily sales register 16 (FIG. 1). If the POS device 12 is integrated with the present invention, the server at an individual restaurant or store 10 may be provided with rights which are limited to access to the POS terminal entry.

[image]

### Ranking Module

The Ranking Modul, a screen display from which is shown in Table 8, provides various comparisons and rankings of individual stores or groups of stores or regions of stores or the entirety of the business. Under ranking any data item contained in daily sales register 16 also can be examined on an individual store basis between two different accounting periods. For example, the complimentary food and liquor registers of daily sales register 16 could be examined for the first week in October for two successive years to determine how the restaurant was performing with respect to complaints regarding food or service. This comparison assumes that such complimentary food and liquor is directly related to customer complaints which is not always the case. Such comparisons can be made on an individual store 10 basis or between two stores or between groups of stores, or it can be examined on a company-wide basis.

[image]

Trends Module

Any of the features that are tracked in the Sales Reporting Module can be presented graphically in the Trends Module, a screen display from which is shown in Table 9, including any comparisons made between preceding years and the current year. The benefit of the graphically trending section is that anomalies are quickly pointed out through the graphing function and can be examined by inspecting data corresponding to the date period of the spike.

[image]

### Vendor Checks

The vendor checks module allows the accounting department of central management 26 (FIG. 1) to print out all checks that are to be issued centrally. While in a preferred embodiment this module does not connect with a bank or print out checks that are manually written by the individual stores such functionality could be incorporated into the module. As shown in Table 10 the vendor checks module does display and keep an accounting of manual checks that are written in the individual store, to the extent that the manual check written at the store is written to an approved vendor. One of the principal benefits of the vendor checks module is that a store can write a manual check or a check on a store account, and that information is immediately entered into the system and can be immediately transmitted to the accounting office of central management 26. This permits the central management to know immediately what check a particular store 10 has been issuing.

The vendor check module allows central management 26 to write checks for individual stores. This is an important feature for should the data connection or Internet connection between store 10 and central management 26 be compromised, store 10 can telephone central management for entry of the information for any checks that need to be drafted. The vendor check module does not populate any other modules such as sales reporting. The central management accounting department can extract information from the vendor checks module to import into an accounting package to track all accounting issues of individual stores as well as the company as a whole. Essentially the vendor checks module is a convenient on-line communications package for transmitting information about checks written, or authorized to be written, by individual stores.

[image]

### Par Inventory

The Par inventory module presents stores 10 with data and reports showing their average or “Par” quantity or stocking of individual items of inventory. If a store orders two or three times a week, over time it will be apparent that their Par quantity of an item on their inventory shelf should be four (4) of that item. If the actual store 10 inventory shows only two of such items, the store manager immediately understands the need to order at least two more of that item to maintain their basic inventory to carry the store through to the next order entry. If a store anticipates an increase in business for the upcoming period, they may wish to increase their Par amount of inventory. The Par module avoids the manager developing a projection to understand what quantity of any particular item is needed to operate the store until the next regular ordering period for supplies. The Par module provides the manager with a historical analysis of inventory use during equivalent periods of the year.

The Par module avoids overstocking in stores and prevents the holding of needless excess inventory by quickly indicating to a store manager when the supply of an object is in excess of or is below the regularly anticipated quantity that should be maintained on hand. It should be appreciated that a new store that has just opened will need to maintain a higher inventory, of higher inventory Par, since the velocity of inventory through the store will be higher due to the novelty of the store. After the store has been in business for several years, and the novelty has subsided, the Par inventory can be reduced. Conversely, as stores become established and their general level of business increases, the Par value for inventory items will need to be raised to contend with the increased demand.

The Pars module calculates the usage of each item based upon the store's total dollar amount of sales per week. Therefore, if a store is selling $50,000 worth of food per week, and 250 steaks are associated with that $50,000 in sales, this would mean, assuming that consumer buying habits remain the same, that one steak is associated with each $200 in food sales. Therefore, when the restaurant's business rises to an average of $60,000 per week, the restaurant can appreciate that it will need approximately 300 steaks per week to meet consumer demand.

This same analysis can be applied to different periods of the year. As the store moves into the holiday period and sales increase for that period, the projected increase in dollars can be used in conjunction with the Pars module to temporarily increase the stocks of items maintained within the restaurant. The Pars module operates by using the sales dollars figure for each week and data for the menu mix register 14 (FIG. 1) for the same week. The information from the menu mix register from a particular restaurant 10 is broken down, using the recipe multiplier, into the individual ingredient items required to produce the quantities of menu items sold as reported by menu mix register 14. The quantities of ingredients thereby determined are divided into the weekly sales dollars of the store or restaurant 10 to determine the inventory of ingredients that is related to the weekly sales dollars figure. In this manner, ultimately, a restaurant will understand that, for example, for each $10,000 in sales, the restaurant must maintain an inventory of 50 steaks to satisfy the public's demand. This correlation can change over time, however, due to purchasing changes in the consuming public and thus is not static.

The Pars module is used to project inventories for managers by examining the increase or decrease in sales for a period of time just preceding the PARS estimate and determining whether sales are up or down and the related percentage. This percentage increase or decrease in sales is then incorporated into the Pars calculations to project for the manager increases or decreases in inventory within the store in view of changes in sales volume. For example, if sales in the current year are found to be up by 5%, that additional percentage can be applied to the Par for each inventory item to result in an increase of the on-hand inventory by the percentage indicated by the dollar sales figure. The Pars module can examine the projected increase or decrease in sales figures from previous years to increase or decrease inventories resulting from the start or end of a holiday period or other annually occurring period such as the start or end of a college academic year. Such periodic events may tend to increase or decrease restaurant sales for that time of year. This information results in a guideline for the manager who will adjust the Par inventory quantities up or down slightly depending on the experience the manager has had and the quantities of an item available to be ordered. For example, under the Pars projection, it may be indicated that 297 steaks are needed. Since the steaks are only offered in boxes of five steaks per box, the manager will increase this to 300 steaks. Alternatively, if the Pars module projects that 50 maple leaf sugar cake desserts are needed, but the manager recognizes that due to impending war between Canada and Vermont, that U.S. citizens are boycotting Canadian products, the manager can eliminate the maple sugar cakes from the inventory.

### Ideal versus Actual Inventory Usage (IvA)

As previously discussed the method of the present invention provides a store 10 (FIG. 1) and a central management 26 (FIG. 1) a means for tracking and identifying the over use or the waste or the loss of inventory items and ingredients that are used in store 10 generally and specifically in the food or menu items served by the restaurant. In general the method of the preferred embodiment comprises determining the quantities of ingredients that are optimally or ideally needed to produce each menu item provided to customers and comparing those “ideal” quantities to inventory quantities used by examination of store inventory the quantities of ingredients that are actually used during a period of time by factoring those quantities into the quantity of each menu item provided to customers and the total number of menu items provided to customers during a user selected the period of time.

Several data conversions and/or multipliers which are described hereinafter are applied to achieve these data which allow the comparison of “ideal” ingredient or inventory usage to “actual” ingredient or inventory usage. The result is a comparison of the optimal or ideal usage of ingredients or quantity of ingredients or inventory items needed to supply the quantity of menu items provided to customers and a calculation of the actual usage or quantity of ingredients or inventory items that were used by a store 10 to supply the quantity of menu items provided to customers. These calculations enable comparison on an ingredient or item basis and the variance between ideal usage and actual usage and the associated cost is identified. In Table 11 a comparison of the Ideal vs Actual usage and associated cost for a number of inventory items is shown. These variances are then associated with the menu items which contain the ingredients or items to allow the management to examine the preparation of the menu items that are outside of the desired ingredient usage specifications.

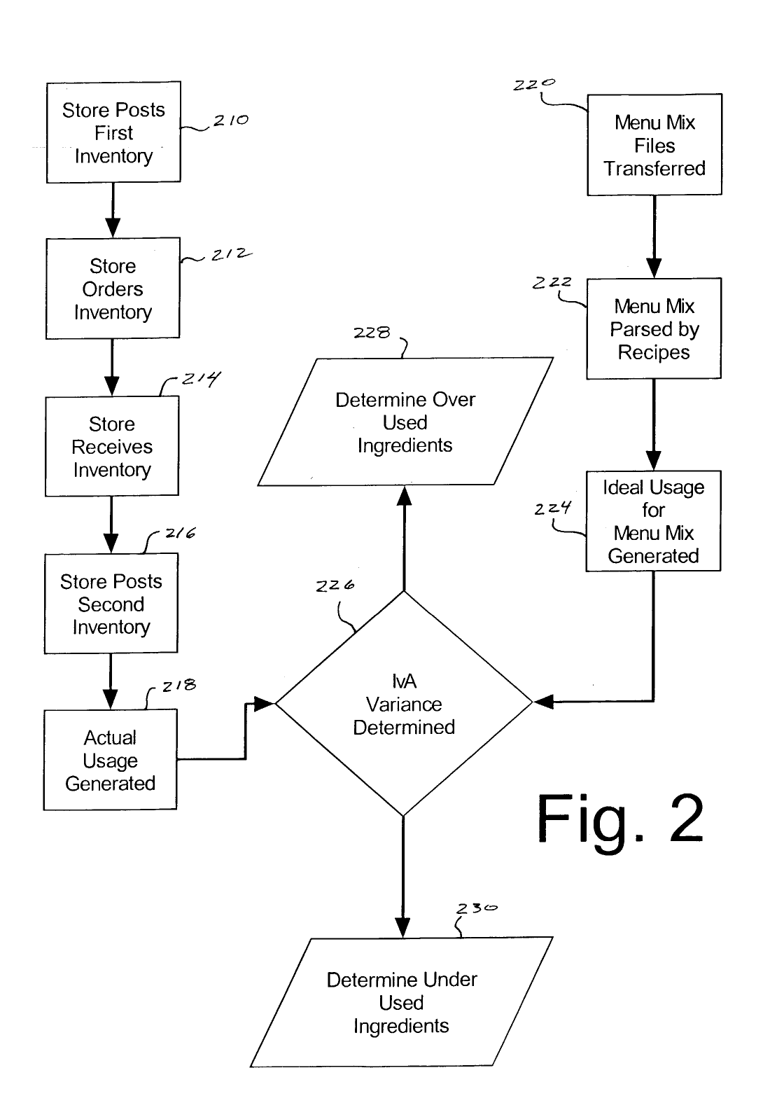

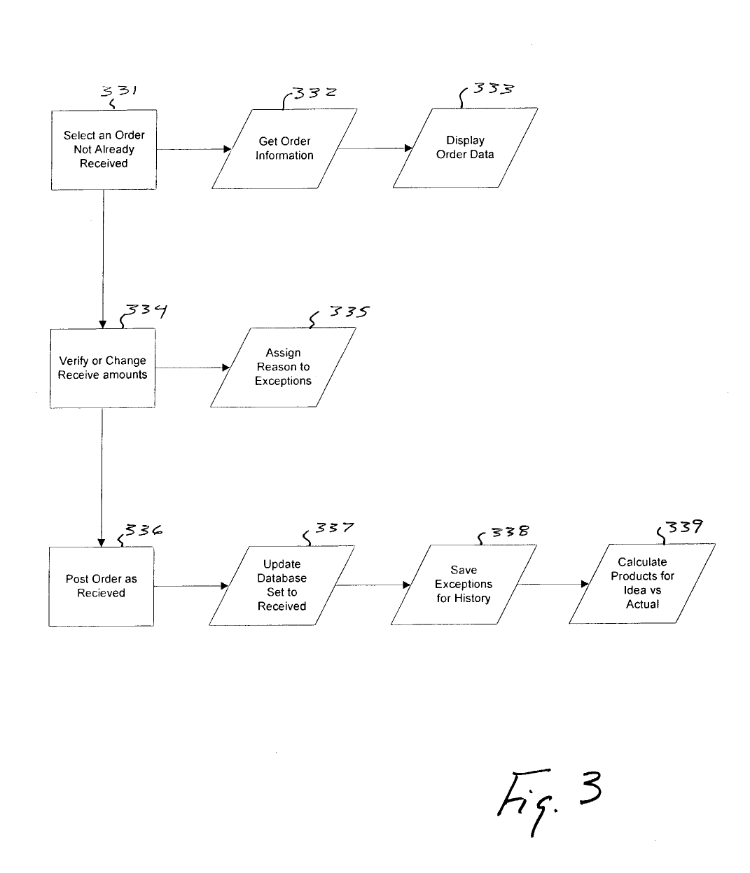

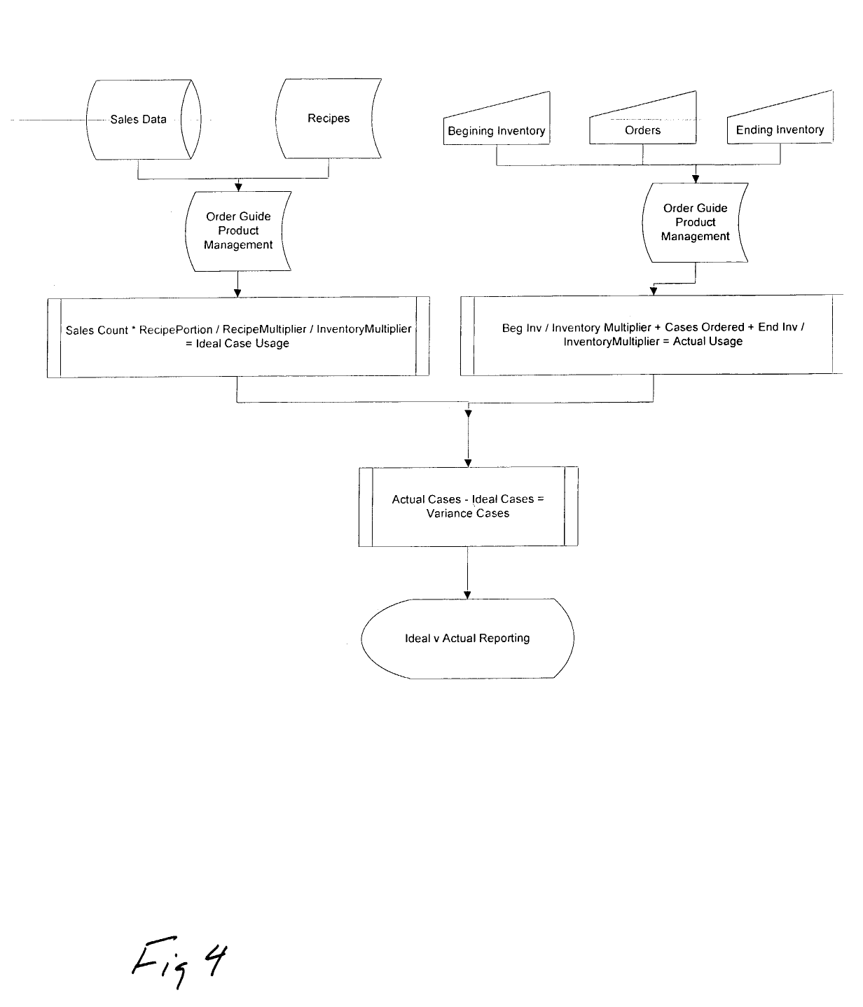

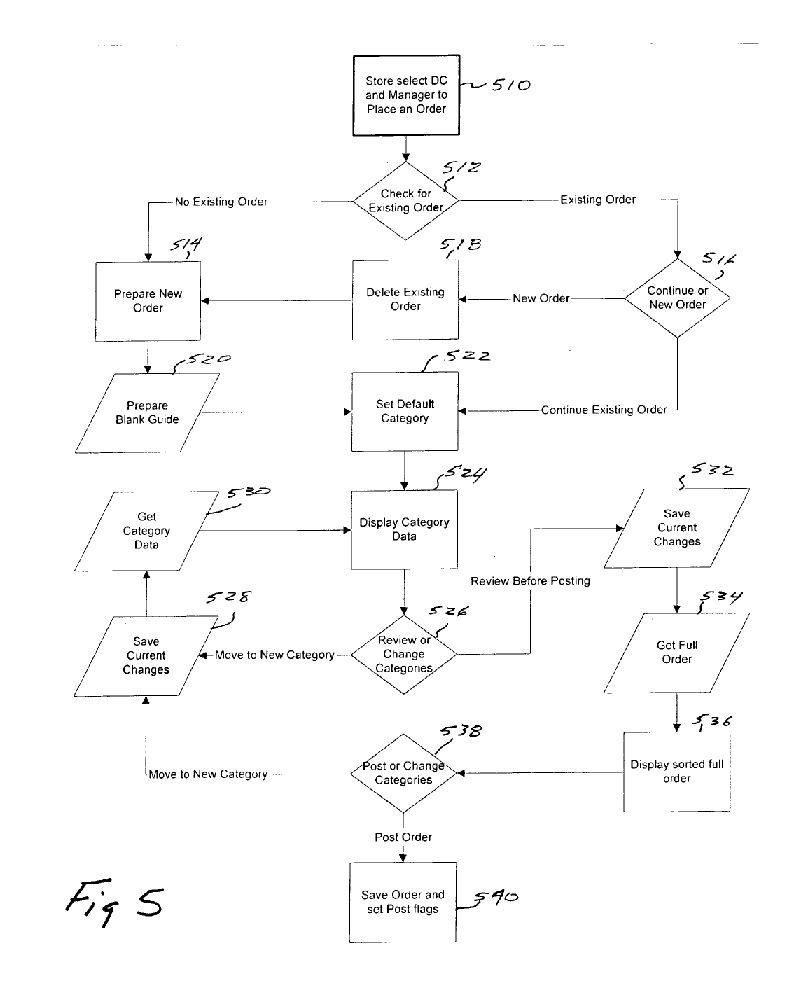

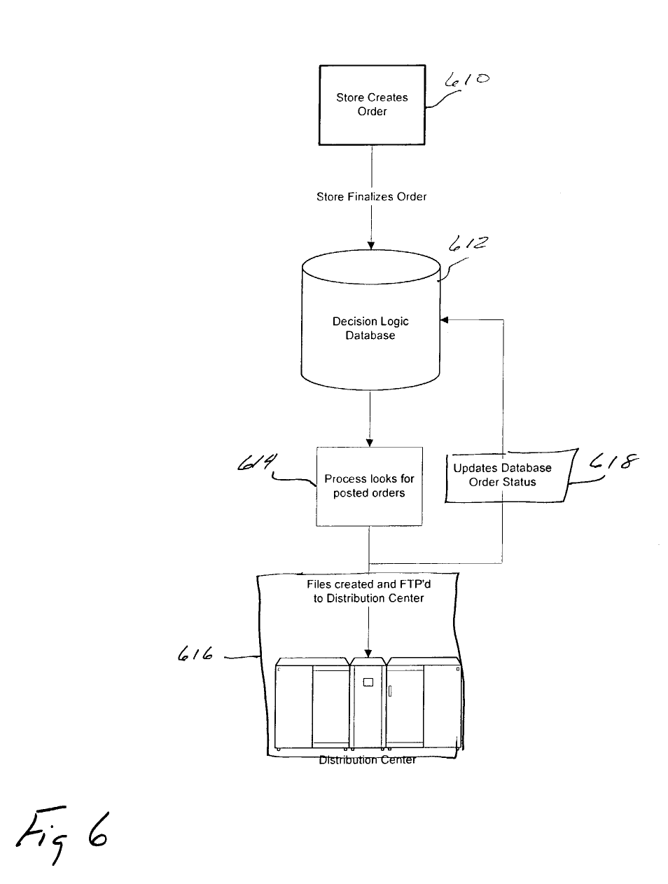

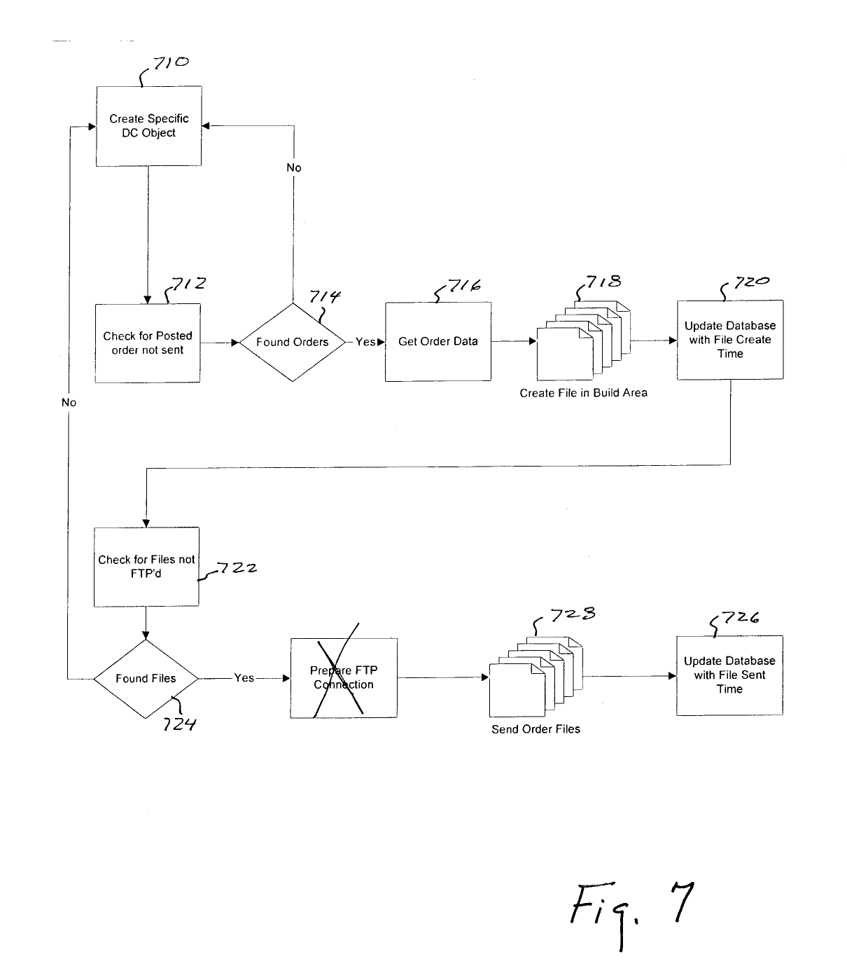

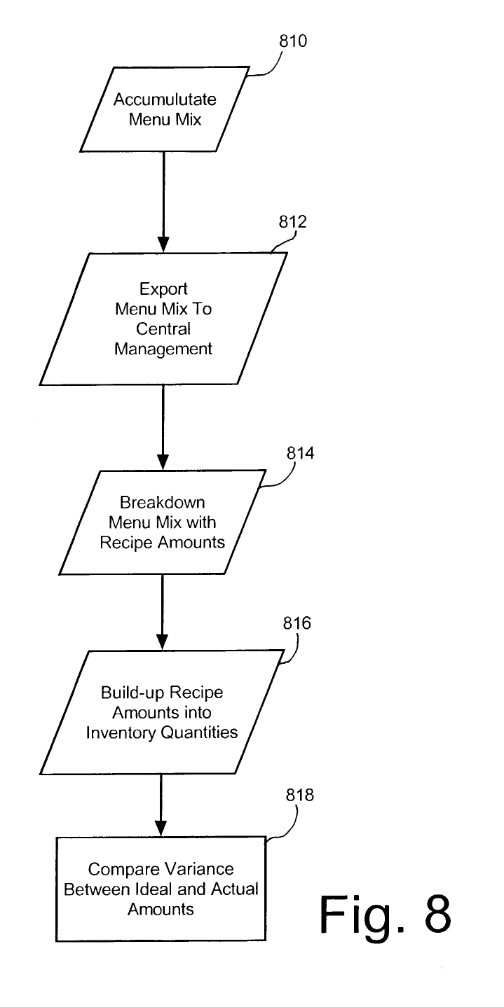

As shown in FIG. 2, the determination of the actual usage of inventory items by a store 10 is one part of the Ideal versus Actual (IvA) determination. The actual usage of ingredients or inventory items is determined, generally, by finding the beginning or starting inventory Step 210 of a store 10 for a user selected period of time, adding to the starting inventory the amount of inventory items received Steps 212, 214 during the user selected period and subtracting from that total the inventory of the store at the end of the user selected period of time Step 216. This provides the quantity of inventory items actually used by the store for a particular period of time Step 218. This quantity, for any particular inventory item, may not yet be in a state that allows for examination and comparison of the ingredients inventoried. The calculation of proper comparison quantities requires application of several conversion factors to the inventory quantities found in a store 10 for a particular period of time

One such factor is a recipe amount multiplier. The recipe amount multiplier is used in the present invention to provide a correlation between a specific menu item and the ingredients used to produce the menu item. In general, the recipe multiplier To continue with the example of avocados, two avocado recipes may be on the current restaurant or store 10 (FIG. 1) menu—guacamole and the fresh sliced avocado with balsamic vinaigrette dressing. The recipe multiplier for the guacamole would be ½ each as ½ of an avocado is used to prepare the menu portion of guacamole that is served with tortilla chip. On the other hand, the fresh sliced avocado with balsamic vinaigrette dressing would have a recipe multiplier of 1 each as 1 avocado is used to prepare the menu portion of that dish.

To determine ideal usage, and again referring to FIG. 2, the contents of the menu mix register 14 (FIG. 1) for a user selected period of time is transferred step 220 from a store 10, which provides the tracking of each item sold by this store 10 during the period of time of interest. The total number of each menu item sold by the store is converted using the recipe factor or recipe amount factor step 222. This generates the ideal usage of ingredients at the recipe quantity level step 224 that a store would have used in preparing the total number of items identified in the menu mix register as being provided to customers for the user designated period in question. After additional operations on the ideal usage of ingredients at the recipe quantity level a comparison between actual usage and ideal usage is enabled which determines the variance step 226 between ideal usage and actual usage for the store for the selected period of time. The variance can then be analyzed as between over usage of ingredients step 228 and under usage of ingredients step 230. It should be noted that the ideal usage calculation is similar to the Pars calculation, however, under the Pars calculation, a dollar figure can be associated with the quantity of each ingredient sold, that dollar figure being obtained from the weekly sales for the store.

The variance for each item derived from the IvA is then multiplied by the dollar figure per quantity attached to the ingredient, and a ranking is provided to the store based upon the expense from highest to lowest of the ingredient items which vary from ideal usage. For example, while there may a total variance of 50 additional portions of sour cream used by the restaurant during the week as compared to ten additional steaks used by the store for the week, the steaks will rank higher on the variance comparison as the cost of the ten steaks is far higher than the 50 one-ounce portions of sour cream.

Referring now to FIG. 8 the determination of ideal usage under the IvA module will be further described. In step 810, the menu mix register 14 (FIG. 1) is developed in each store 10 (FIG. 1) based upon the sales of menu items each day to customers. The generated menu mix register is then exported from the store in step 812 and sent to the central management 26 (FIG. 1). In step 814, the received menu mix register data is broken down into the individual recipe amounts or quantities that, ideally, would have been required to be used to prepare the total number of menu items specified in the received menu mix register 14. Once the amounts of individual recipe ingredients is determined, the recipe amounts resulting from the menu mix register can be converted into the total inventory quantities of recipe amounts step 816 and items which represent the ideal usage of inventory items the store or restaurant 10 would have used to produce the quantity of store products served to customers shown in the menu mix register of step 810. Once the ideal usage has been obtained in step 816, that ideal usage can be compared with the actual usage of inventory items step 818 as determined from taking the individual store inventory. The variance between ideal usage and actual usage is then determined.

Referring now to Tables 11-15, the results of IvA ingredient usage and cost analysis are shown. In Table 11 the variance of ingredients is shown from highest cost variance to lowest cost variance. In Table 12 the IvA Ranking of each store 10 (FIG. 1) is tabulated. In Table 13 the Top 20 variations by cost under the IvA method are shown. In Table 14 the Negative Usage of items is shown on a cost basis. In Table 15 the separate analysis for the IvA of beer sold in one store 10 is tabulated. This presentation of IvA usage allows

[image]

[image]

[image]

[image]

[image]

both management and each restaurant manager to examine each particular ingredient item and/or menu item to which a variance can be attributed. It will be recalled that this precise and specific assignment of usage error cannot be achieved through use of a “theoretical food cost” method of operations analysis as the “theoretical food cost” method offers only a gross comparison of the money spent to produce a quantity of restaurant items and does not point to the ingredients being pilfered or to the menu item or items wherein the waste is occurring.

For example, referring to Table 11, the central management product identification number is listed in column marked “Prod ID” of Table 11 for each item that is presented in the IvA usage variance charting. A description of the item is shown in the next column marked “description.” Columns showing the “variance” and “portion” reveal that 93 ounces of Bacon-Bits Precooked ½″ were used in excess of the ideal usage. This represented a cost of $20.21 for the reporting period and which was 0.046% of the store's sales. It will be appreciated that each item listed in description column is a link to each one of the menu items in which the item is used. This allows the store manager to “click” on the description and reveal each menu item in which Bacon-Bits Precooked ½″ are used. This tracking by ingredient item and associated menu item allows the company management and store management to examine the menu items associated with the out-of-specification ingredient usage, and focus on the preparation of those particular menu items to determine if waste is occurring during the preparation of these items. Alternatively, such examination of the particular restaurant may demonstrate to the manager of the restaurant that an inventory error has occurred. For example, an examination of the overuse of chocolate cake may indicates that ten slices were used in excess of the ideal usage. This may prompt the store manager to realize that this was likely an inventory error as this was a dessert which is frequently listed during inventory receiving check-in as “not on the truck.” In this case the manager may check the inventory received for that week and determine that the chocolate cake containing ten slices was not actually received, but was inadvertently marked as being received on the inventory received list.

Referring now to Table 14, the negative variances between ideal and actual usage or under usage of ingredient items is shown. As previously described, the central restaurant management or individual store management can select a product description from the “Description” column and call up a display of the menu items in which the ingredient is used. For example, the description of “sauce-maple” could be selected to determine which recipes this ingredient is used to determine why 268 fewer ounces of maple sauce had been used by the restaurant. It may be discovered that servers are simply pouring only a single ounce of maple sauce onto the designated recipes instead of the required two ounces of maple sauce. Alternatively, investigation may show that the maple sauce is used in the baked ham steak with maple syrup menu item, and that due to the week long Weight Watchers® convention, the wait staff had been advised by customers to “hold the maple syrup” from the ham steak recipe. Since a request to “hold the maple syrup” is unusual, the store POS device 12 (FIG. 1) was not equipped with a “hold the maple syrup” key and the result was an unusual, but trackable, variation from the expected or the “ideal” usage of maple sauce.

Examination of Tables 11-14 shows that any period of time can be selected in the date drop down boxes to produce the IvA results of inventory usage for inspection by either central management or a particular restaurant.

Yet another example of the utility of IvA is the cross checking of the ingredient breakdowns of particular recipes. For example, Table 11, “Ideal vs Actual” shows that 19 beef-ground chuck patties 4 oz. were used in excess of ideal. By selecting the description “ground beef-ground chuck patties 4 oz.” all the menu items will be displayed which contain these ground beef patties. The person investigating, whether it be at central management or the individual restaurant, can then select each one of the menu items and examine the listed ingredient makeup for that particular menu item. In the case of ground beef patties, the restaurant manager may discover that the recipe for the Hickory Burger lists only a single hamburger patty to be used in the recipe when, in fact, the recipe amount specifications for the dish call for two beef patties to be used. In this manner, the investigator could determine an error in the recipe amount conversion and also correct an error in the IvA report for that ingredient item. Thus, by linking together the IvA reporting, the menu mix register reporting and the recipe amount ingredient breakdown and the menu or recipe specification cross checking of data used in the present inventive method provides management with investigative assistance as it attempts to track down errors in purchasing, inventory, and menu and ingredient use reporting.

Another benefit of the association between IvA usage and the menu mix register 14 (FIG. 1) is that the store manager can observe that the restaurant is actually selling far more than the two “marinara burgers” than is listed in the menu mix file. This realization may cause the manager to discuss the issue with servers and determine that rather than the servers pressing the “marinara burger” button at the POS device 12, the servers are instead pressing the “hamburger button” and the “add marinara” button. This is the cause of a negative usage variance in the marinara sauce as the kitchen is correctly preparing a marinara burger having only one-half ounce of marinara sauce, whereas the “add marinara” button indicates in the menu mix register that the customer was served a three ounce ramekin of marinara sauce. Yet another example of the utility of the IvA negative usage list of Table 9 is shown by examining the use of “potato-French fries” which shows a variance of 1,468 ounces of French fries that were not used and which should have been used according to the menu mix register for that restaurant. A large variance such as is shown for French fries in Table 9 may very well be due to inaccurate inventory. On the other hand, this may indicate that the customers are frequently asking that the French fries be left off the plate in a particular menu item. In the restaurant business, this is known as the customer asking to “86” the fries. This type of data can indicate to management the need to include on the POS terminal a button for excluding the French fries, or other item, from the dish ordered by the customer. In this manner, the IvA usage will be more accurate, and the inventory of French fries maintained in the restaurant can be reduced, as well as the associated cost eliminated.

Another advantage of the present invention is that it will provide nearly real-time analysis of food usage and costs and restaurant operation costs as opposed to the typical theoretical food cost model. Under the typical theoretical food cost model, the central management or the restaurant must wait for invoices to be submitted for the food items received from vendors. This typically presents a thirty-day delay for the invoices to be received and the information must then be collated, reports generated, and the results examined or sent out to local restaurants. Thus, by the time the restaurant receives the information, the management is, at least, thirty days distant from the time period for which the information was generated. As a result errors and mistakes cannot be easily recalled or determined and inventories cannot be rechecked. Under the present method, the receipt of information is virtually instantaneous, and upon submission of a restaurant's actual inventory, the restaurant can have the results of its IvA within minutes, and certainly no more than hours. This allows the restaurant management to cross check IvA usage with inventory and determine whether any errors existed in the taking of the inventory or in the operation of the restaurant which might affect the IvA usage. For example, if a case of chicken fingers was inadvertently left off the closing inventory for the period, the usage of chicken fingers would appear to be substantially higher than normal. Since the restaurant receives the IvA information back from central management within a matter of minutes or hours, the restaurant is able to recheck its inventory and determine whether or not it was an inventory error rather than improper food usage which has cause the substantial increase in the use of the food item, in this case, chicken fingers.

### Multiple Menu Controls Modules

As will be appreciated from the description herein of the Multiple Menu Controls Module, different menus are used for different stores and thus in calculating the IvA for a store the menu differences must be taken into account. As previously stated, IvA is only run for items that appear on both the store menu mix register and the store inventory guide. This then automatically accounts for differences between the menu items served at different stores. More Specifically, some products will be sold at some stores and some products will be not sold at those stores. If the product is not sold it doesn't enter into the menu mix and therefore doesn't enter into the IvA. This is an advantage over the theoretical food costs since generally theoretical food cost is done on a generalized basis of the total cost of food for the store, and since different individual menu items which appear in one store but not in another would skew comparisons between stores under the theoretical food cost basis. Under the IvA model the aspects of food service operation that can actually be controlled by the store, that is, waste of ingredients or pilfering or inventory loss are the issue examined rather than uncontrollable issues such as the cost to purchase food which is not immediately reflected in changes in menu price.

The operation of IvA also accounts for preparation shrinkage in various inventory items. For example, with respect to french fries, a portion of french fries which is to be placed on the plate to be served to a customer is 6.5 ounces of french fries. However, the frozen weight of that cooked 6.5 ounces of french fries is actually 9 ounces prior to cooking. Therefore, if only a recipe amount and inventory multiplier were applied to the items identified in the menu mix register, 10 portions of french fries would equal 65.0 ounces of french fries which would not correlate with the amount of inventory used by weight which would be 90 ounces of french fries for the 10 portions of french fries served to customers. Therefore in addition to the recipe multiplier which would be one recipe portion equals 6.5 ounces and inventory multiplier is used which is one portion equals 9.0 ounces of inventory french fries. Therefore for purposes of IvA it is an important distinction that 100 pounds of frozen french fries will yield only 11.11 customer servings (100 divided by 9.0) rather than believing that 100 pounds of french fries uncooked will yield 15.38 customer servings (100 divided by 6.5) in the calculation of ideal versus actual usage. This calculation of course must be taken into account as the menu mix register 14 (FIG. 1) is reporting customer servings but this quantity is being ultimately compared to inventory use by the restaurant. In the case of french fries this results in cooked portions of french fries being compared to the amount of frozen french fries used to produce those portions of french fries reported in menu mix register 14. Therefore if the difference between the cooked and uncooked weight is not taken into account a discrepancy will exist between the weight of french fries delivered to customers versus the weight of french fries used from inventory to produce that quantity of french fries delivered to customers. The foregoing information represents an additional factor which is taken into account depending on the particular product and the manner in which it is inventoried and this factor is known as shrink. This factor is in addition to the recipe multiplier and the inventory multiplier.

### Inventory Reporting

The inventory reporting module provides a history of store inventories so management 26 can examine historical trends in the inventory any store 10 has maintained. The inventory reporting module allows management to view the inventory of particular items over the history of a particular store or of several stores. Inventory reporting allows the velocity of items kept in inventory to be determined. The velocity of an item being the rapidity with which the inventory item comes into a store and is used by the store. Item velocity allows central management to advise distribution centers of the amount of inventory of each item which will be needed in the future.

Velocity can be examined by two methods. One method is the examination of usage, and the other method is the examination of items ordered. A benefit of examining velocity appears when a group of restaurants under a single management is embarking on offering a promotional item to the public. A promotional item would be, for example, a ten dollar steak platter being offered for six dollars. During such a promotion, the number of steaks sold—that is the velocity of steaks in inventory—will be quite high. An examination of the inventory reporting records can determine exactly the type of increase in steak velocity due to such a promotion. This enables central management 26 to notify vendors and distribution centers in advance of the impending promotion the number of additional steaks that will be needed. Such advance forecasting and notice avoids the problem of vendors and distribution centers running out of the promotional item during the promotion.

Another use for velocity determinations occurs when new vendors or distribution centers are hired to supply the restaurants or stores 10. It is not uncommon for new distribution centers to disbelieve the quantities of food items needed by stores 10 and the rate or velocity with which those food items will be required. The inventory reporting module permits central management 26 of a store 10 or a group of restaurants to prove to new vendors and distribution centers the reliability of their projections for food ordering. These data then convince new distribution centers and vendors to maintain on hand the volumes of food that the restaurant will require. In this manner the typical problems related to an initial break-in period of a new vendor or distribution center can be avoided. These problems result from the new distribution center disbelieving the projected quantities of food that will be used by the store 10 or restaurant chain and, therefore, not maintaining sufficiently high supplies of food items during the start of the new relationship. This results in the distribution center frequently running out of food items until the new vendor or food distribution center comes to accept the veracity of central management's reports. Also, in the case of promotional items, the inventory reporting module can be used to support central management projection of food requirements to distribution centers during promotional item periods when a store or restaurant 10 having to tell a customer that they are out of the promotional item takes on the appearance of a bait-and-switch tactic.

### Distributor and Purchasing Module

The Distributor and Purchasing Module provides tracking and reports on the reasons for variations in orders received. The information for this module is loaded from Order Entry Module 18 and is based upon the Received Order Screen shown in Table 4. As previously described, when an order is received the store manager indicates the actual quantity of the items that were actually received off the truck. The manage also notes the reasons for items not being received. These reasons are, for example, “not on truck”, “temporarily out,” “discontinued,” “damaged,” or “substituted.” Under the Distributor and Purchasing Module, central management 26 can examine and review the ability of a particular distributor or vendor to provide, over time, various items and to call to the attention of the distributor failures which appear to be consistent.

For example, the Distributor and Purchasing Module may show that dessert items are most frequently those that are “not on the truck.” This can be due to poor attention to loading the truck, or it can be due to the items being taken by those loading the trucks, or it can be due to the items being eaten by persons driving the trucks. In any event, the ability of central management to point out to distributors the quantities of particular items are most frequently missing allows the distributor to pay particular attention to these items and to work to eliminate this delivery discrepancy.

Another benefit of the Distributor and Purchasing Module is in identifying a particular distributor or delivery route that is failing to perform properly as compared to other distributors or delivery routes. The information contained in the distributor purchasing reporting module can be used to detail this failure and to support the decision to either retain the distributor or to terminate dealings with the distributor.

The Distributor and Purchasing Module further provides a price change report which shows an increase or decrease in prices from one distributor bid period to another distributor bid period. This information is particularly useful where the restaurant operation controlled by central management 26 is sufficiently large to engage in contract pricing with vendors and distribution centers. This then allows the central management to quickly assess which products have increased or decreased in price and to alert management to the need to revise the pricing of particular items and determine whether or not the cost of a menu item should be increased or decreased.

The Distributor and Purchasing Module can use the data provided inventory entry module 20 to allow central management 26 to give vendors and distributors advance notice of the restaurant chain requirements for a particular food item for a period of months. This then permits the distribution centers or vendors to obtain quotes on that quantity of the food item from its own vendors. For example, it may be determined that each of five restaurants are using 300 fourteen ounce steaks per week. This permits central management to request a bid for the third quarter of the year for a total bid on 35,100 steaks each to be fourteen ounces. This type of specific information allows the restaurant chain to provide advance notice to its distributors and thereby to obtain the best pricing available by allowing the distributors to obtain bids from meat vendors. The obtained contract price is then entered into the Distributor Purchasing module, and central management 26 can cross check the contract price with the invoices received from distributors to determine that, in fact, the distributor is complying with the contract price.

### Order Reporting Module

The Order Reporting Module contains a history of the items each store 10 has ordered, and received so central management can examine the entry and use of inventory in stores over user selected time periods. The Order Reporting Module assists stores in determining if errors exist in their IvA by allowing a store to go back and actually determine whether or not items ordered were, in fact, received. When a store receives an order, the store management only can download a copy of what was actually ordered. Store management cannot make changes to that downloaded copy. Store management only can enter the quantity of the item received. If the item is not received properly, the store management can indicate the reason for the discrepancy. In this manner the whole order is not re-entered by the manager, and errors from that aspect are eliminated. Once the quantity of items actually received is entered, the manager posts the received order form shown in Table 4, and this data is posted to the store's inventory.

Referring now to FIG. 5, when a store desires to place an order, the store manager brings up the order module and selects the distribution center at which the order is to be placed in step 510. The store is connected to central management via the Internet or other convenient data transmission form, and the query is sent into central management in step 512 to check for any existing orders from that store for the particular distribution center. If there is an existing order, the store manager in step 516 can either select to continue with the existing order or elect to delete the existing order in step 518 and develop a new order. If, on the other hand, no existing order is found in the system, the store manager will initiate a new order in step 514. If a new order is selected in step 514, a blank order guide will be transmitted to the store location in step 520, and the default category of inventory location in the store 10 (FIG. 1) such as produce, walk-in, freezer, or dry storage etc. will be selected by the manager to allow order selection placement for that inventory location.

This selection of an inventory location category results in displaying of the category data in step 524 in which the description and item number and package and size of each item available in the category is displayed, the manager can then select the quantity of each item desired. Once that has been accomplished, the store manager will review the current category or decide to change categories in step 526. If it is determined to change categories, changes to the current category are saved in step 528 before the new category data is obtained from the central database in step 530. The store manager can then make changes to the quantities desired to be ordered in the new category in step 524 and review those changes in step 526 before deciding to post the order to the central management office. Any changes made will again be saved in step 532, at which point, the entire order about to be placed by the manager will be retrieved in step 534 and displayed in step 536 for review or change in step 538 before the order is finally posted to the central office in step 540 whereupon it is acted upon by central management before being dispatched to the distribution centers. Central management 26 will divide the order from store 10 across the various vendors and distribution center that are contracted to provide particular items.

An overview of this process is shown in FIG. 6. The process just described and shown in FIG. 5 is found in step 610 of FIG. 6 wherein the store creates an order. Upon the store finalizing the order, the order is transmitted to the central management office database. In step 612, the store's order is divided among the various vendors and distribution centers that are contracted to provide inventory items and the order is then combined with other posted orders from other stores which are ready for transmission to a vendor or distribution center. Instep 614, the group of orders are then transmitted to the distribution center electronically in step 616, and the fact of transmission of the order to the distribution center is then noted in the central office database in each order file in step 618.

Referring now to FIG. 7 the transmission logic related to gathering posted orders from stores into a general order to be transmitted to a distribution center is shown. This corresponds to the steps taken in step 612 of FIG. 6. In step 710, a file or object for a specific distribution center is created. In step 712, the program then checks for posted orders from stores that have not been sent to distribution centers. If orders are found in step 714, those orders are acquired in step 716 and a file for each order is prepared in step 718. The file created in step 718 is a part of the distribution center object created in step 710. Once the file for transmission has been created in step 718 and attached to the distribution center file or object of step 710, the file is labeled with a file create time in step 720. The program then checks for additional files that have been prepared for the distribution center but have not been transmitted in step 722. If files are found in step 724, they are combined with the distribution center object created in step 710. The located files are updated in the database with a file sent date and time in step 726 and in step 728, the files are transmitted to the distribution center.

Another item tracked under the Order Reporting Module is intra unit transfers. This is the transfer of inventory items between restaurants. Such a transfer may occur when it is convenient and time is critical and one restaurant has an excess of a supply of an item, or at least the amount needed to see the restaurant through to receipt of its next order, and a nearby restaurant is without an item. The restaurants can transfer the items back and forth and account for these transfers by reporting them to the central management office database. In this situation, the inventory is removed from one restaurant and credited to another restaurant. The inventory reporting module is then updated, and the updated information is ultimately used in calculating the IvA usage by each restaurant.

It should be noted that when placing an order, a restaurant is able to order on a distribution center basis, that is to bring up an order form for a particular distribution center showing all the items provided by that distribution center. The store can then select those items and submit an order on a distribution center basis. Alternatively, the store can prepare and send its order on a store inventory location basis in which the store manager proceeds to different locations in the store in which inventory is kept, and the order form that appears on the manager's screen will present all the items that are available and are kept within that inventory location. Under this ordering system, the manager will submit an order based on the needs of the store, and when the order is received in the central database location, the order will be parsed into the various distribution centers which provide the items ordered by the store. Once the order has been placed, the order information is parsed out to the various modules within the software such as inventory reporting, IvA, PARS.

### H.R. Forms

The H.R. Forms Module contains human resources forms which are used by the restaurants on a regular basis. Forms such as accident report forms, employee tax forms, employment applications forms, etc. can be maintained under H.R. Forms and downloaded and used by the individual restaurants as needed. This provides the benefit to stores of avoiding the need to maintain current forms at each store and assists the central office in prompting management to fill out and submit forms on a timely basis.

In particular, the employee accident report form is critical to have filled out on a timely basis, and the transmission of this form to the central office from an individual restaurant allows the form to be reviewed by human resources personnel in the central management office and to assess the degree of completion of the form. If the form is incompletely filled out, or if the description of the incident is sketchy, the human resources personnel can quickly revert to the particular restaurant manager for additional details before recollection of the accident has passed from memory.

### Manager Scheduling Module

The Manager Scheduling Module allows a store 10 (FIG. 1) to schedule managers for the coming week. As shown in Table 16, morning and evening, or a.m. and p.m., manager times are scheduled. During periods of heavy customer traffic overlaps in the managers' attendance at the stores can be scheduled. The present invention incorporates manager grade ratings which are predicated upon management determinations that are performed outside of the method of the present invention. The rating can be of any hierarchical form. In the embodiment described herein the grade scale is a letter scale ranging from a high of A to a low of C. This grade rating is used within the present invention to determine duty assignments under the manager scheduling module. Under the Manager Scheduling Module a manager is selected and allocated various schedule time slots during a future business time period. Managers having a grade below a predetermined level are not permitted to handle difficult times of restaurant operation by themselves. The present invention allows rapid determination of heavy workload times and presents in a graphical display which managers are assigned to heavy workload periods and their respective assigned management grades.

For example, during a high workload period of a Friday evening a manager with a grade of C or below is not permitted to work a shift alone and be responsible for closing the restaurant during such a heavy customer traffic period of time. A manager with a grade level of C or below, for example, may be a relatively new manager or manager-in-training

[image]

who is not completely familiar with all the closing procedures that must be accomplished. Therefore, such an inexperienced person should not be in the position of closing the restaurant by themselves during a heavy customer traffic period when the workload is high. Using the Manager Scheduling Module a store or restaurant 10 (FIG. 1) can determine its management scheduling quickly and easily in advance, and transmit the proposed schedule to upper level management or central management 26 for approval by an area manager or by central management. By contrast, for example, on a light business evening it may be entirely permissible for a C level manager to close the restaurant by themselves as the late night customer load is very light, thus allowing time for the C level manager to focus on the closing of the restaurant tasks. As a further example, it would not be considered advisable to have C level managers both opening and closing the restaurant. Under central management requirements it may be that at least one of those positions must be filled by a management grade level of B or higher if the other slot is to be filled by a management level person of grade C.

The Manager Scheduling Module, a screen display of which is shown in Table 16, is available only to the particular store 10 for which the scheduling is being conducted. The determined schedule is available to upper level managers for review but cannot be examined by other stores. An advantage of the Manager Scheduling Module is that it promotes objectivity and impartiality in scheduling as it forces the assignment of manager schedules to be associated with a manager's qualifications rather than the ease or difficulty of a particular schedule time period.

### Order Guide Control Module

The Order Guide Control Module allows the ordering data displayed to each individual store to be modified and presented to each store 10 individually. This equips each individual store with a specific selection of items from which the store can order and allows the excluding from stores, again on an individual basis, items which the store is not allowed to order. Since the ordering data displayed to each individual store is called up and downloaded by each store via an on-line or Internet connection between the store 10 and central management 26 the store ordering data is centrally developed and controlled by use of the Order Guide Control Module by central management.

While the same food vendor may be supplying all stores, stores in, for example, Nebraska are not allowed to order and sell T-bone steaks whereas stores in the of Texas are permitted to sell T-bone steaks. The Vendor is unlikely to consent to or be trusted to redact its ordering list to prevent the Nebraska stores from ordering T-bone steaks. The Order Guide Control Module allows central management 26 (FIG. 1) to eliminate T-bone steaks from the on-line ordering guide used by each of these stores on an individual or collective basis. In the case of T-bone steaks central management can allow the steaks to appear on the one-line ordering guide for the Texas stores while preventing the T-bone steak item from appearing on the order guide for Nebraska stores. In this manner, the central management does not have to spend time reviewing actual orders submitted by individual stores, rather, the ordering limitations are set centrally by the management using the Order Guide Control Module.

Another use of the Order Guide Control Module is in controlling the ordering and therefore the inventory of stores that offer completely different dining opportunities. It can be the case that central management operated some stores serving only lunch and dinner and also operates some stores that serve breakfast, lunch and dinner. The Order Guide Control Module permits the entirety of breakfast items to be excluded from the on-line order guide used by restaurants serving only lunch and dinner thereby eliminating a source of confusion and inappropriate inventory stocking.

The Order Guide Control Module allows the elimination from store ordering guides items which simply should not be in any restaurant, but which are available from the vendor being used to supply the stores. Food service areas and restaurants are not, generally, under health standards to use aerosol or spray type pest control agents. While the vendor supplying the restaurants will very likely offer such substances for sale, the food service providers and stores 10 (FIG. 1) should not be purchasing or stocking such items. The Order Guide Control Module allows central management 26 to exclude items offered by the vendor or distribution center to other customers of the vendor or distribution center and to only include for store ordering those items which the particular store 10 is permitted to have in its inventory. This allows the Order Guide Control Module to be used by central management 26 to insure that each store 10 complies with local food and health regulations without the need to individually review each store's orders.

The Order Guide Control Module also permits restrictions on “broken case” ordering by individual stores 10. “Broken case” order is the purchasing of less than all of the items provided in a standard package or case of an item. For an extra charge a vendor or distributor will open a case and remove and deliver only the quantity of an item actually ordered by a store 10. There are times when such “broken case ordering provides a cost savings to a store. Other times the extra cost charged by the vendor or distribution center is more than the cost of the “unbroken case” or in situations in which the store has the possibility of using the extra items prior to spoilage the store may avoid an unnecessary surcharge by simply having a slightly higher inventory of the item than would normally be dictated by the Pars Module described herein.

As previously stated, it is possible to pay a premium and have a distributor “break a case” and only deliver four items out of a 12-item carton to a particular store. The Order Guide Control Module allows central management to make this determination on a store by store basis. Stores having a high velocity of inventory items through the store, for example, may not be permitted to purchase any “broken cases” inventory items as central management 26 has determined that the additional charge by the vendor for supplying “broken case” items exceeds the value to the stores having extra items on hand or exceeds the cost to the store of simply buying an entire case of the item. By contrast, for example, stores having a low velocity of certain inventory items may be permitted to purchase “broken case” quantities of the same item as the low usage of that inventory item in that particular store indicates that the cost savings is achieved by purchasing the “broken case” quantity of the item.

The Order Guide Control Module also permits central management to insure accurate ordering and accurate inventory and to ordering confusion by modifying vendor product descriptions on the order guides viewed by individual stores 10. It often can be the case that the description applied to a product by a vendor is either cryptic or does not sufficiently describe the item in a manner that is easily recognizable by restaurant management. The Order Guide Control Module permits central management 26 (FIG. 1) to provide a different or modified description of the product which is then viewed by the manager at store 10 (FIG. 1) but which does not modify the description of the item on the order form that is ultimately transmitted back to the vendor. This is accomplished by maintaining the vendor or distribution cent item numbers or the UPS codes within the item description, but changing the description the manager of store 10 views to provide a meaningful description of an inventory item on the order guide while. The vendor or distribution center views a different but equal meaningful description of the same product when the order placed by store 10 when the order is received by the vendor or distribution center.

This feature of the Order Guide Control Module allows central management, if it chooses, to identify inventory items in a manner more closely aligned with the menu descriptions used in a store 10 rather than relying on store management to make a translation between these store menu description and the vendors inventory description. It may be more convenient for store management to remember and order “Hawaii chicken breasts” which coincides with the menu item of “Hawaiian chicken” rather than learning to recognize the vendors description of the same chicken breast of “6.5 oz. scb-pine stuffed”. By allowing for a different description as between the inventory items presented to the manager of store 10 and the descriptions used by the vendor or distribution center the amount of mistaken ordering is reduced which reduces the amount of restocking charges to a store by a vendor or distribution center and reduces the amount of incorrect inventory contained within the store. Therefore it would be appreciated that while the vendor distribution's center bid file shown in Table 6 will contain pricing for every item offered by the vendor or distribution center, the order guide viewed in store 10 will only contain a sub-set of the items offered by a vendor or distribution center and the descriptions may be different from those presented by the vendor or distribution center. It should also be appreciated that while the descriptions of the items may be changed on the ordering guide viewed by store 10, the vendor item numbers and the UPC codes (if shown) will remain constant thereby allowing consistency of product ordering between a store 10 and the vendor's distribution centers.

The Order Guide Control Module offers a further cross-check of inventory ordering by being a separate management controlled listing of the inventory items available for a store to order. It occasionally occurs that a vendor or distribution center will eliminate an item from the bid file, an example which is shown in Table 6, when the item should not be eliminated. By having a separate order guide presented to a store 10 which is developed by central management the vendor's inadvertent elimination of an item from its bid file does not automatically eliminate that item from appearing on the store's ordering guide. The separate maintenance of the order guide made available to stores by central management 26 allows mistakes and changes made by vendors in distribution centers and the inventory of items available to be ordered to be immediately apparent to central management and to be immediately corrected by central management 26 before any individual store 10 is affected by the vendors error or change.

### Inventory Control Module

The Inventory Control Module operates under many of the same principles as the Order Guide Control Module in that the Inventory Control Module allows for specific development of inventory listings for individual stores 10 based on the items which the store is allowed to order and maintain within its inventory. As previously described, some stores or restaurants 10 (FIG. 1) will be permitted to carry breakfast items as those stores serve breakfast whereas other stores only serve lunch and dinner and will not be permitted to carry breakfast items in their inventory. The Inventory Control Module allows these sorts of individual store variations to be taken into account in the development of the on-line inventory screens used by individual restaurants in taking store 10 inventories.

An important aspect of the Inventory Control Module is modifying the inventory guide displays which are presented to an individual store 10. One reason for this inventory guide modification results from the need for different stores to order and receive different size packages of different items. For example, a store in New Mexico may, on the average, sell a far less quantity of pork ribs as compared to a store in Nebraska. Due to this distinction the store in New Mexico may only be permitted to order ribs in 20 pound cases rather than the 30 pound cases which stores in Nebraska order. This difference must be represented on the ordering guides and the inventory guides so the taking of inventory accurately reflects the package sizes received by the particular store. This inventory guide modification occurs in the Inventory Guide Control Module. This separation between the ordering guide seen by a store and the inventory guide seen by a store provides a further check on the accuracy of the IvA calculation as IvA is not calculated for an item which does not appear both in the ordering guide for a store and the inventory guide for a store.

### Analysis Tools Module

With the Analysis Tools Module various data points can be gathered to allow determination of customer flow through a restaurant. In entering a customer order into POS device 12 (FIG. 1), the time at which a server enters the order is recorded. Central management 26 (FIG. 1) is then able to analyze the flow of customers through the restaurant. This analysis of customer flow indicates the times of day the restaurant is busiest and can be expected to be busiest on a regular basis. This information is used to notify servers of the customer population at any given time of the business day. It also is used to indicate the length of wait a customer is experiencing as the arrival time of a customer can be entered into the POS terminal by the greeter or host or hostess of the restaurant. Tracking of this information allows servers to be notified when it is considered desirable to avoid prompting customers to purchase deserts and more desirable to encourage customers to purchase appetizers. This shifting of ordering encouragement by the server can assist in maintaining customer orders at a high level while reducing the time one set of customer is at a table and reducing the time another set of customers is having to wait for a table.

The advantage of this use of the Analysis Tools in the method of operation results from a customer, while at a table and waiting for preparation and serving of the entree, being able to consume appetizers while waiting for the entree, without extending the length of the customer's use of the table. On the other hand, when deserts are offered to customers the deserts tend to be consumed by fewer than the total number of individuals at the table and the consumers tend to linger over the deserts. This extends the length of time the customers are is at the table while achieving only a minimal increase in sales for that period of time. The better alternative during high customer flow is to avoid encouraging deserts in favor of encouraging the eating of appetizers to increase table turnover and the ability to serve more customers during peak dining hours.

A further advantage of use of the Analysis Tools Module in the present method of operation is the charting of customer count during all times of the day. This permits store manages to make staffing decisions which correlate with the customer population and peak dining hours.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive plasmapheresis apparatus and method are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. A method of food service management comprising:
entering a menu item order at a point of service terminal, said menu item being comprised of at least one ingredient portion,
updating a menu item order register by said menu item order,
revising a daily sales register by said menu item order,
determining an actual ingredient usage of said at least one ingredient portion for a menu item,
determining an ideal ingredient usage of said at least one ingredient portion for a menu item,
calculating a variance between said ideal ingredient usage and said actual ingredient usage for at least one ingredient portion, and
reporting said variance.

2. A method of determining ingredient usage in a food service operations comprising:
finding an actual usage amount for at least one ingredient of a menu item of the food service operation comprising the steps of:
determining a starting inventory quantity of said at least one ingredient at the beginning of a user selected time period,
adding to said determined starting inventory quantity a quantity of received shipments of said at least one ingredient for said user selected period of time to provide a total inventory quantity of said at least one ingredient for said user selected period of time,
determining an ending inventory quantity of said at least one ingredient for said user selected period of time,
subtracting said ending inventory quantity from said total inventory quantity to provide said actual usage amount of said at least one ingredient for said user selected period of time,
finding an ideal usage amount for at least one ingredient of a menu item of the food service operation comprising the steps of:
determining a recipe amount of said at least one ingredient for said menu item,
determining a total quantity of said menu item sold during said user selected period of time,
multiplying said recipe amount of said at least one ingredient with said total quantity of said menu item sold during said user selected period of time to provide a total recipe amount,
operating on said said total recipe amount with at least one inventory factory to provide an ideal usage amount for said at least one ingredient for said menu item, and
comparing said actual usage amount with said ideal usage amount.

3. The method as claimed in claim 2 further comprising the step of identifying a category of menu items containing said at least one ingredient.

4. The method as claimed in claim 2 further comprising the step of calculating a variance between said actual use inventory quantity and said ideal inventory usage quantiy and ranking said variance according to cost.

5. The method as claimed in claim 2 further comprising the step of calculating a variance between said actual use inventory quantity and said ideal inventory usage quantiy and associating said variance with management efficiency.

6. The method as claimed in claim 2 further comprising the step of calculating a variance between said actual use inventory quantity and said ideal inventory usage quantiy and associating said variance with management compensation.

7. The method as claimed in claim 2 further comprising the step of calculating a variance between said actual use inventory quantity and said ideal inventory usage quantiy and associating said variance with employee compensation.
